(19) United States
(12) Patent Application Publication
(10) Pub. No.: US 2008/0256201 A1
(43) Pub. Date: Oct. 16, 2008

(54) System and method for communicating messages using alias addressing

(75) Inventors: Joseph M. Flowers, Newbury Park, CA (US); Guy Botham, Hollywood, CA (US); Robert Haefliger, Pasadena, CA (US)

Correspondence Address: DRINKER BIDDLE & REATH (DC), 1500 K STREET, N.W., SUITE 1100, WASHINGTON, DC, 20005-1209, US

(73) Assignee: TELEFLIP, INC.

(21) Appl. No.: 12/010,729

(22) Filed: Jan. 29, 2008

Related U.S. Application Data
(60) Provisional application No. 60/898,360, filed on Jan. 29, 2007.
(60) Provisional application No. 60/898,361, filed on Jan. 29, 2007.

(51) Int. Cl. G06F 15/16

(52) U.S. Cl. 709/206

(57) ABSTRACT

A method and system for routing email messages to a recipient across disparate communication networks, by addressing the recipient using a pre-assigned alias. The alias may be an alphanumeric identifier that is associated with the recipient device, or a nickname that is associated with an alphanumeric identifier that is associated with the recipient device. The alphanumeric identifier is network independent across carrier networks, such as the recipient's wireless phone number or a nickname. The sender addresses an email message using the alias to a messaging server, without having prior knowledge of the wireless carrier dependent syntax for email addressing the recipient. The messaging server determines the corresponding wireless network carrier that services the recipient's particular recipient as identified by the alias, and the appropriate wireless network dependent syntax for email messaging to the recipient.

### PRIORITY CLAIM

This application claims benefit from U.S. Provisional Patent Application Nos. 60/898,360 and 60/898,361, both filed on Jan. 29, 2007, the entire content of both applications being incorporated herein by reference.

### CROSS-REFERENCE TO RELATED APPLICATIONS

Related subject matter is disclosed in U.S. patent Ser. No. 11/053,528, filed on Feb. 7, 2005, and in U.S. Provisional Patent Application No. 60/533,094, filed on Feb. 13, 2004, the entire content of both applications being incorporated herein by reference.

### BACKGROUND OF THE INVENTION

1. Field of the Invention

The present invention relates to a system and method that enables messaging between recipients at networks having disparate address syntax and/or protocols. More particularly, the present invention relates to a system and method for managing and forwarding email, alerts and other messages or Internet content to mobile and landline telephones utilizing, for example, a website.

2. Description of the Related Art

In telecommunication networks, such as cellular wireless networks, various messaging services are available to the subscriber/users, as alternative means of communicating at times when the initiating party and the targeted recipient may not be simultaneously available for or may not desire real time voice communication to take place. Such messaging services include email messaging, voicemail messaging, short message service (SMS) text messaging, multi-media messaging service (MMS), and so on. Some of these services are carrier, provider, network or platform dependent (collectively referred hereinafter as “network dependent”, as opposed to network independent), and some are user device dependent. Network dependent refers to messaging services that would work in one network (e.g., carrier, provider, platform or physical network) but not another, because of differences in operating protocols, parameters, specification, limitations, and other characteristics among the different carriers, providers, platforms or physical networks. Such differences may include incompatibilities arising from underlying technologies, communication frequencies, the communication platform including the underlying hardware and software that handles communication over a network communication protocol and/or simply the physical or operational limitations imposed on network providers and/or carriers (e.g., email addressing syntax, such as email domain address), to distinguish their services.

For example, in cellular carrier networks, voicemail messaging has typically been network dependent. Each network may be associated with a different provider that implements a different hardware and/or software platform, and/or utilizes a different set of communication and/or data protocols. For voicemails, each cellular carrier (e.g., AT&T, Verizon, Cingular, Sprint, T-Mobile, etc.) maintains a proprietary voicemail system within its own carrier network. While a person in one cellular carrier network may call another person in another cellular carrier network to leave a voicemail message, voicemails are not transferrable from one cellular carrier network to another simply by messaging the voice mail file. However, within the same cellular carrier network, a sender may be able to record a message and forward the message to a designated recipient. Hence, voicemail messaging is not available across dissimilar cellular carrier networks and dissimilar platforms within the same network.

SMS text messaging provides a convenient way of communicating short messages, and it is typically not network dependent. As long as a carrier offers SMS text messaging as a service to its customers, SMS text messaging is compatible over disparate cellular carrier networks. A sender in one network can send an SMS text message to a recipient in another network. Most cellular handsets are enabled with SMS text messaging function. However, a sender is typically required to use the text entry interface of his or her cellular phone to input his or her message, which may be inconvenient and tedious. Another option would be to use a cellular carrier proprietary browser interface to send SMS text messages. However, this requires the sender's prior knowledge of both the recipient's cellular carrier and the web address for the carrier proprietary browser interface, which necessarily requires additional efforts on the part of the sender and defeats the advantage of convenience of SMS text messaging.

Email messaging to a recipient on a cellular network may be deemed a more elaborate form of SMS text messaging, which requires an email address of the recipient (e.g., 1234567890@providerx.com), in which “1234567890” is the targeted recipient's cellular phone number, and “providerx.com” is the email domain unique to the particular cellular provider. As long as various network providers provide for email services and user cellular phones are email-enabled, email messages may be sent and delivered as SMS text messages (sometimes referred as SMS email messaging) across different cellular carrier networks. The sender can send emails from an email-enabled cellular phone of one cellular carrier to another email-enabled cellular phone of another cellular carrier, or from a device connected to the Internet (e.g., via wired or wireless communication) to an email-enabled cellular carrier.

As can be appreciated, if the sender uses a cellular phone to write an email, it is often tedious and cumbersome to input the text entry. If the sender instead uses an Internet-connected device, such as a desktop computer, text entry would be more convenient via a keyboard. However, the sender still must have prior knowledge of the recipient's email address, which requires prior knowledge of the particular email domain name unique to the particular cellular carrier.

There are several methods in use that enable email recipients to receive email on their mobile phones. In some instances, users must download a software program or programs to their mobile phones; these programs in turn facilitate the delivery of email. Mobile phone users can also use internet-based email client programs, such as Google's Gmail or Yahoo's Yahoo! Mail, to retrieve emails from their mobile phone's browser. Accessing such applications requires the purchase of a mobile phone company data plan. Special purpose “Smart Phone” devices, such as RIM's Blackberry and Palm's Treo, for example, enable quick access to email, but such mobile phones can be costly to buy, and the mobile phone companies' data plans upon which such phones rely can be costly as well. Also, mobile phone and other telephone users can sign up at a variety of web sites to initiate the delivery of alerts or internet content, but the delivery of such information frequently requires the initiator to know the domain name and email address syntax required by his mobile phone provider.

Accordingly, even if the networks are compatible from a data transfer perspective, the syntax or protocols for addressing the recipients are not network dependent. Senders need to have prior knowledge of the syntax, format or protocols for addressing particular network carriers such as cellular networks carriers. Therefore, it is desirable to provide a further improved messaging system that will further improve ease of email addressing a recipient using an alias.

### BRIEF DESCRIPTION OF THE DRAWINGS

These and other objects, advantages and novel features of the invention will be more readily appreciated from the following detailed description when read in conjunction with the accompanying drawings, in which:

FIG. 1 is a conceptual diagram illustrating an example of a messaging network in accordance with an embodiment of the present invention;

FIG. 2 is a flowchart illustrating an example of operations which enable a user to establish, access and manage an account for using the network as shown in FIG. 1 in accordance with an embodiment of the present invention;

FIGS. 3-17 are exemplary screen displays that occur during the process shown in FIG. 2;

FIGS. 18 and 19 are flow diagrams illustrating exemplary operations performed by the network shown in FIG. 1 for performing messaging according to an embodiment of the present invention;

FIGS. 20 and 21 are exemplary diagrams illustrating examples of the flow of a message in the network as shown in FIG. 1 in accordance with the operations shown in FIGS. 18 and 19;

FIG. 22 is another flow diagram illustrating exemplary operations performed by the network shown in FIG. 1 for performing messaging according to an embodiment of the present invention;

FIG. 23 is a diagram illustrating an example of a server included in the network shown in FIG. 1;

FIG. 24 is another flow diagram illustrating exemplary operations performed by the network shown in FIG. 1 for performing messaging according to an embodiment of the present invention;

FIGS. 25 and 26 are further flow diagrams illustrating exemplary operations performed by the network shown in FIG. 1 for performing messaging sending and receiving according to an embodiment of the present invention; and

FIG. 27 is a flow diagram illustrating exemplary operations performed by the network shown in FIG. 1 for performing scheduled messaging according to an embodiment of the present invention.

### DETAILED DESCRIPTION OF THE EMBODIMENTS

The embodiments of the present invention discussed below relate to an improved method and system for forwarding email messages to a recipient across disparate communication networks, by addressing the recipient using a pre-assigned alias. The alias may be an alphanumeric identifier that is associated with the recipient device. The alphanumeric identifier can comprise an identifier that is uniquely associated with the recipient's device, which is network independent across carrier networks (i.e., the identifier is network independent, even though the recipient device is network dependent), such as the recipient's wireless phone number (e.g., 1234567890). The sender addresses an email message using the alias to a messaging server (e.g., alias@xxxxx.com or recipientx@xxxxx.com), without having prior knowledge of the wireless carrier dependent syntax for email addressing the recipient.

In one embodiment described herein, the messaging server determines the corresponding wireless network carrier that services the recipient's particular wireless phone number, and the appropriate wireless network dependent syntax for email messaging to the recipient, using the process such as that disclosed in the co-pending U.S. patent application Ser. No. 11/053,528 referenced above. The messaging server determines the email domain associated with the particular carrier (e.g., “providerx.com”), and forwards the sender's email content to the recipient using the phone number and the carrier dependent email syntax (e.g., 1234567890@providerx.com), and such content is delivered to the recipient as a “short message service” (SMS) text message.

In another embodiment of the present invention described herein, the sender pre-assigns an alias comprising user assigned (e.g., by sender or recipient, or both with different aliases convenient for each to remember and use) alphanumeric characters (e.g., “recipientx”) for Recipient X's wireless device (e.g., a cellular phone number, such as 1234567890) in an alias database. The sender addresses an email message using the alias to a messaging server (e.g., recipientx@xxxxx.com), without having prior knowledge of the wireless carrier dependent syntax for email addressing Recipient X. In this example, the messaging server looks up the alias database and determines the wireless device phone number associated with the alias. The messaging server then determines the corresponding wireless network carrier that services Recipient X's particular wireless phone number, and the appropriate wireless network dependent syntax for email messaging to the recipient, using the process such as that disclosed in the co-pending U.S. patent application Ser. No. 11/053,528. The messaging server determines the email domain associated with the particular carrier (e.g., “providerx.com”), and forwards the sender's email content to the recipient using the phone number and the carrier dependent email syntax (e.g., 1234567890@providerx.com), and such content is delivered to the recipient as a SMS text message.

The sender may send the email through any device enabled with email function (e.g., a device enabled to communicate with a SMTP server), which may be a desktop information processing device (e.g., a desktop computer), an electrical or electronic device incorporating an information processing device enabled with email function and/or connects to the Internet (e.g., a TV, TV set-top box, cable set-top box, satellite set-top box, telephone system, refrigerator having a built-in device to access the Internet, etc.), a portable and/or wireless device (e.g., a cellular phone, satellite phone, Voice over IP (VoIP) phone, portable computer, personal digital assistant (PDA), digital music play (e.g., MP3 player, iPod player, etc.)), which connects to the Internet. The email message may include a data file attachment. Examples of a data file include a voice message, text document, a musical file, a picture file, a PDF file, an executable file and a multimedia file, to name a few.

While the embodiments of present invention described herein are particularly suitable for use in cellular communication systems, but may find use in other types of mobile or non-mobile communication systems that require unique syntax for email message addressing. Also, the embodiments of the present invention described herein can find utility in a variety of implementations without departing from the scope and spirit of the invention. For example, the email messaging concept employed in embodiments of the present invention may be applied to business and personal communications, and may be implemented by commercial as well as private communication networks incorporating a messaging server in accordance with the present invention. In particular, the embodiments of the present invention provide a system and process that works seamlessly to route email messages across different incompatible network services. Some of the network services are carrier, provider, network or platform dependent (collectively referred hereinafter as network dependent, as opposed to network independent). Network dependent refers to network services that would work in one network (e.g., carrier, provider, platform or physical network) but not another, because of differences in operating parameters, specification, limitations, and other characteristics among the different carriers, providers, platforms or physical networks. Such differences may include incompatibilities arising from underlying technologies, communication frequencies, communication platform which may be viewed as the underlying hardware and software that handles communication over a network, communication protocol which may be viewed as the way data is exchanged among user devices, or simply the physical or operational restrictions network providers and carriers imposed to distinguish their services.

To facilitate an understanding of the principles and features of the present invention, they are explained herein below with reference to its deployments and implementations in illustrative embodiments. By way of example and not limitation, the present invention is described herein-below in reference to examples of communicating email messages over cellular networks.

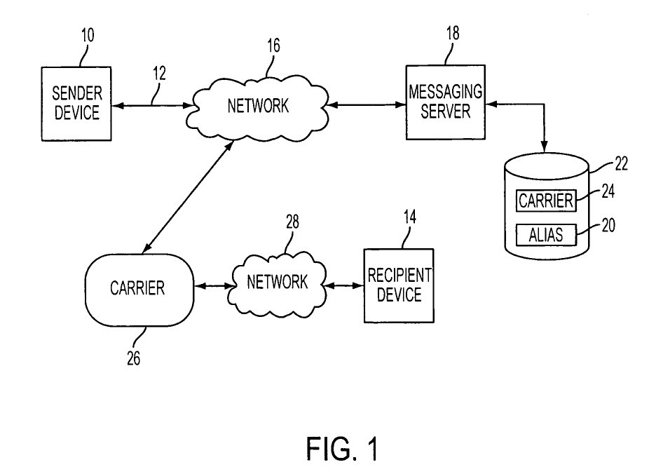

FIG. 1 is a schematic diagram illustrating an embodiment of the present invention where a sender device 10 transmits an email message 12 to a recipient's device 14, which in this example is a wireless cellular device. However, the sender device 10 and the recipient's device 14 may comprise a cellular phone, a PDA and/or portable computer, a fixed device such as a landline phone and a personal computer, to name a few, as well as a VoIP enabled device, which has a unique phone number assigned.

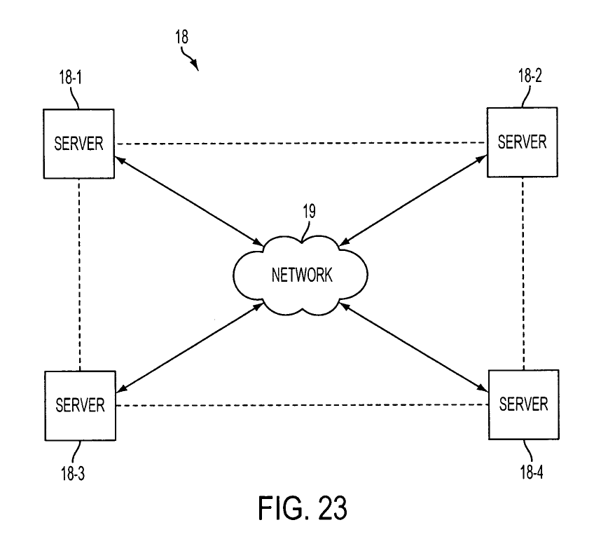

As further illustrated in FIG. 1 and discussed in more detail below, the sender device 10 can send a message or file, such as an email 12, via a data communications network 16 to a messaging server 18. The messaging server 18 can include, for example, an Apache server running a scripting language such as PHP and other servers as described below. The Apache server connects with both TFMain, a MySQL server that holds account information, and a JBoss application server. For illustrative purposes, the servers as show as message server 18 in FIG. 1. Further exemplary details of the server 18 are show in FIG. 23.

For example, as shown in FIG. 23, the messaging server 18 comprises many servers 18-1, 18-2, 18-3 . . . 18-n, that are inter-connected via a network 19 that is coupled to the network 16 in FIG. 1, such as PSTN, cellular, Internet, Intranet, WAN, LAN, etc., with each server 18-1 through 18-n having partial or full functionality of a messaging server as described above, with, for example, each serving a different geographical region. These servers can also include the Apache server, MySQL server and JBoss server as discussed in more detail below. One server 19-1 may forward the email to another server 18-2 (e.g., in a different country), before routing the email to the particular carrier in that locale, so as to streamline routing of the emails to the recipient at a particular locale. Details of various hardware and software components comprising the network 19 (and similarly for the network 10 and network 28 shown in FIG. 1) are not shown (such as servers, routers, gateways, etc.) as they are well known in the art. As will be appreciated by those skilled in the art, the networks 18, 18-1 through 18-n, and 28, may include both hardware and software and can be viewed as including either, or both, according to which description is most helpful for a particular purpose. For example, the messaging server 18 can be described as a set of hardware nodes that can be interconnected by a communications facility, or alternatively, as the communications facility, or alternatively, as the communications facility itself with or without the nodes. It will be further appreciated that the line between hardware and software is not always defined, it being understood by those skilled in the art that such mediums and communications facility involve both software and hardware aspects.

The messaging server 18 can access a database 22 for storing, for example, an alias table 20, a carrier table 24 and other information which are described in more detail below. The database 22 can be updated periodically (e.g., every few weeks) by, for example, NeuStar, Inc., which maintains the Number Portability Administration Center (NPAC) database in accordance with US telecommunications regulations.

For example, the database 22 can be controlled to contact NeuStar and request a Bulk Data Download (BDD) of the 8 North American zones for which the system shown in FIG. 1 has access authorization. NeuStar places the requested BDD on an FTP server. A designated worker, for example, downloads the BDD from the NeuStar FTP server and runs an import script on the downloaded BDD. This script identifies the information in the BDD that is needed to update the database 22, extracts that information from the BDD, and updates the database 22. It should be noted that the database 22 also provides the gateway information associated with each mobile phone carrier. That carrier gateway information does not come from NeuStar, however, but is acquired by the database 22 from other sources. In this example, there are approximately 80 rows of carrier gateway information in the database 22.

As also discussed in more detail below, the network 16 can communicate with a carrier 26, that further communicates via a network 28 with the recipient device 14.

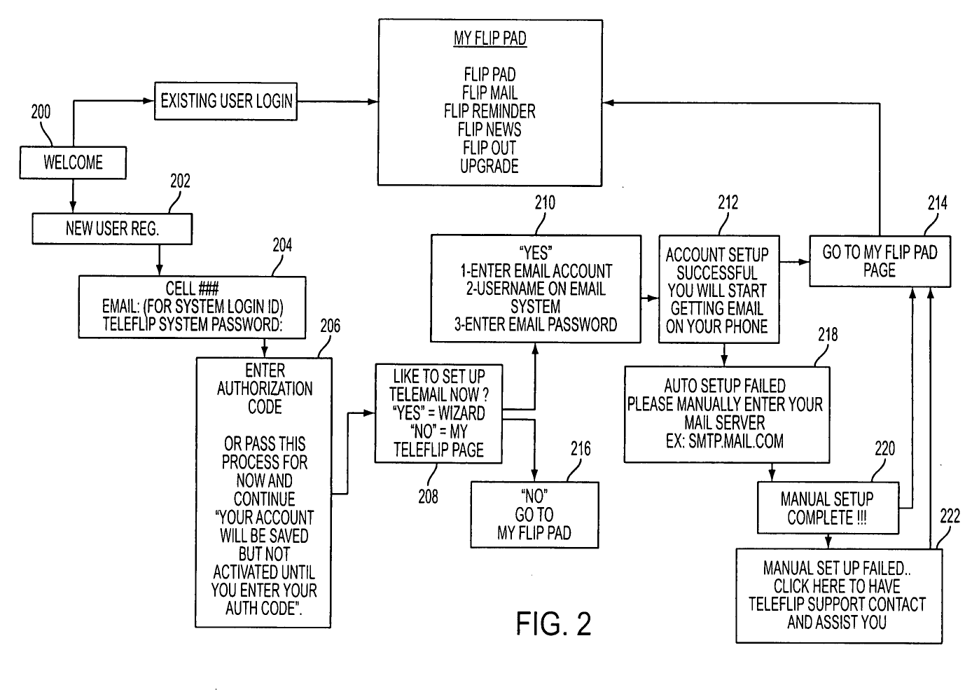

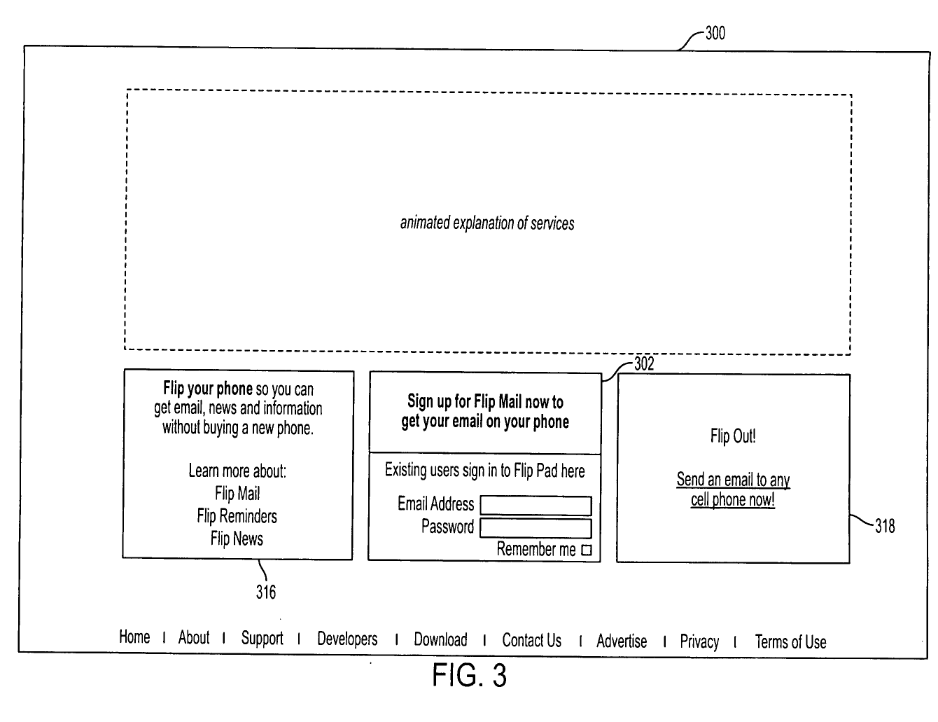

As can be appreciated by one skilled in the art, a user can, for example, use any type of computer having Internet access to log onto a website to set up an account, or access an existing account, to enter into the database 22 information such as the names, passwords, mobile phone number(s), mobile phone alias(es) and other information and preferences of individual user. As shown in the flowchart of FIG. 2, a user logs onto the website in step 200 using, for example, the Internet or any web based interface or a small client side application or related server, to access a welcome screen 300 as shown in FIG. 3. As shown, the welcome screen 300 gives the user an opportunity to sign up for the mail service, or to access his or her existing account via an email address and password.

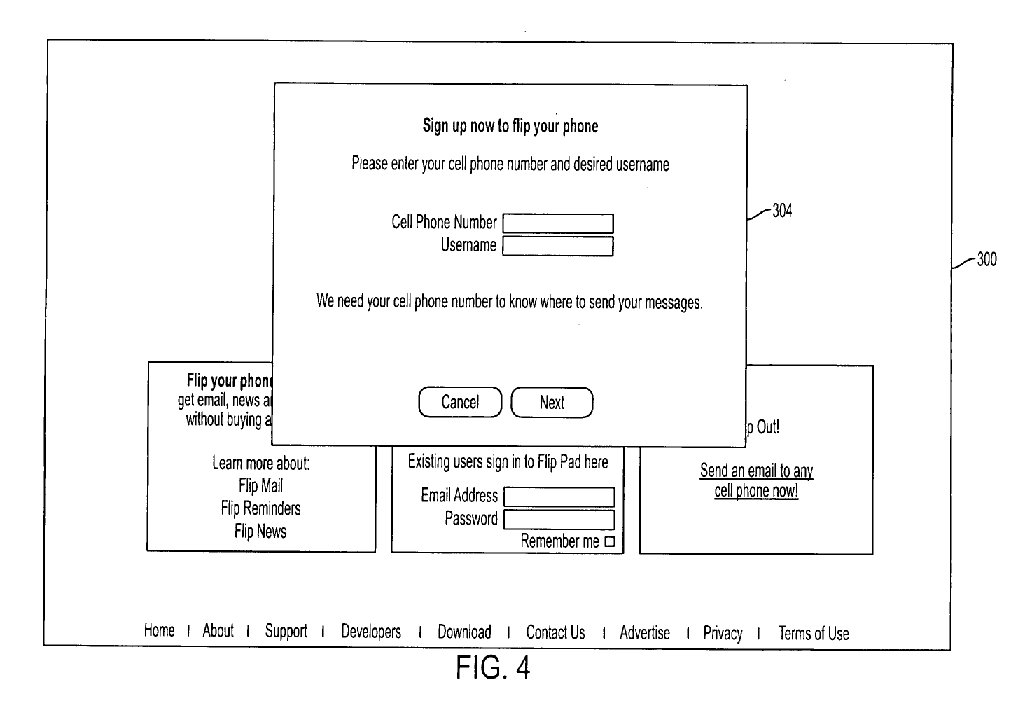

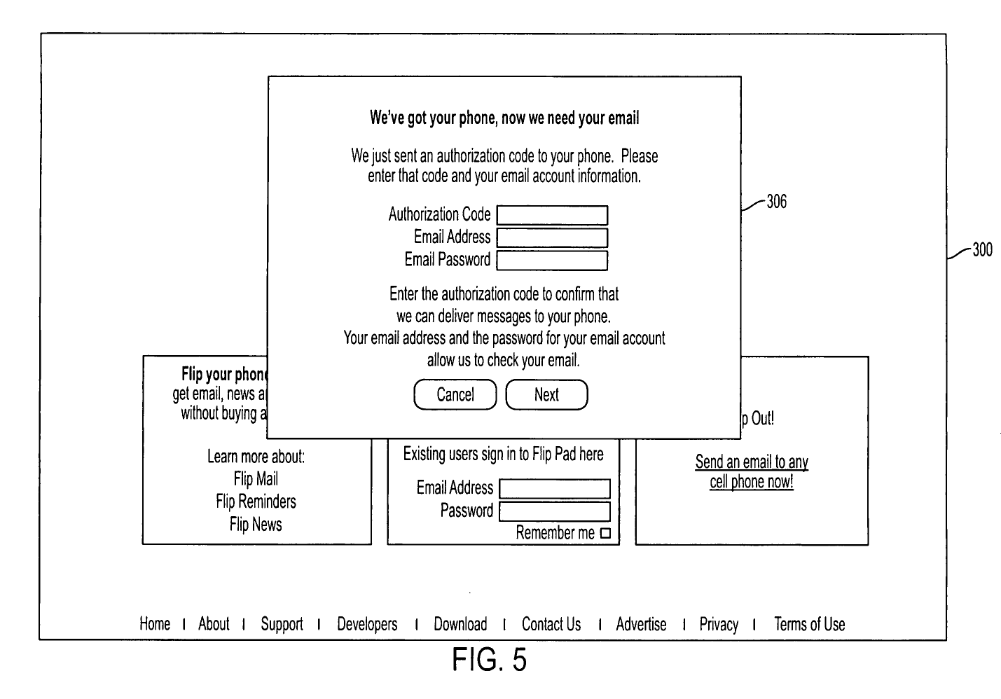

If the user is a new user, the user will begin registering in step 202 by clicking on the “sign up” button 302 shown in FIG. 3. By doing this, a sign up window 304 will be displayed as shown in FIG. 4. The user can then enter his or her cell phone number and a user name as requested. These operations are performed in step 204 of the flowchart shown in FIG. 2. Upon hitting the “next” button in the sign up window 304, another window 306, as shown in FIG. 5, can be displayed which enables the user to enter an authorization code along with his or her email address and password to complete registration and set up telemail. These operations are performed in steps 206, 208, 210 and 212 of the flowchart shown in FIG. 2. Also, the user can bypass the process of entering the authorization code, but would be instructed that his or her account will be saved but not activated until the authorization code has been entered.

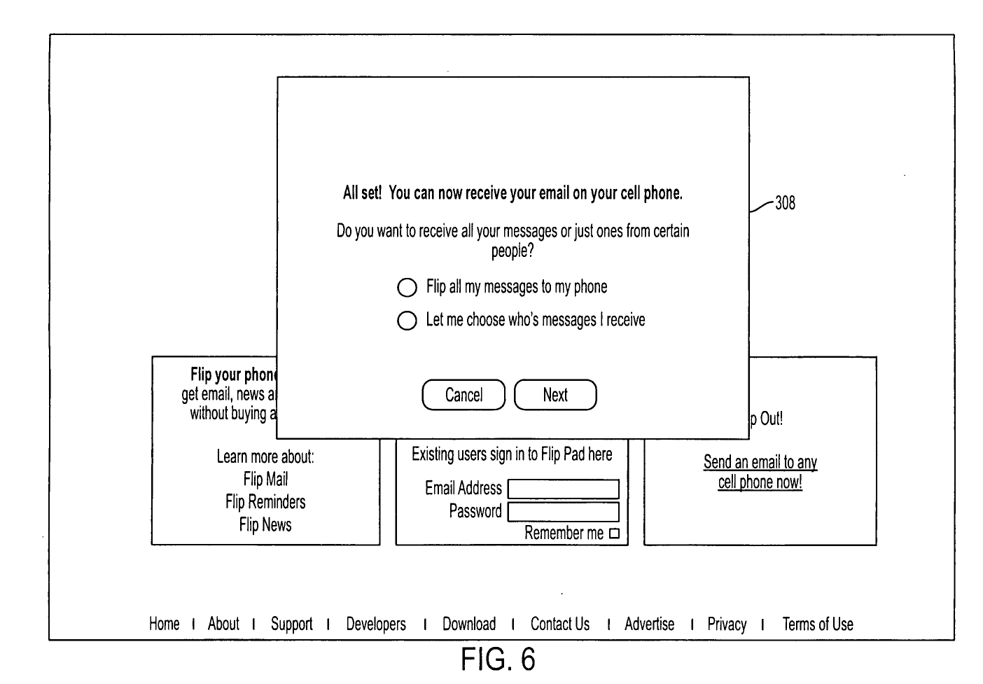

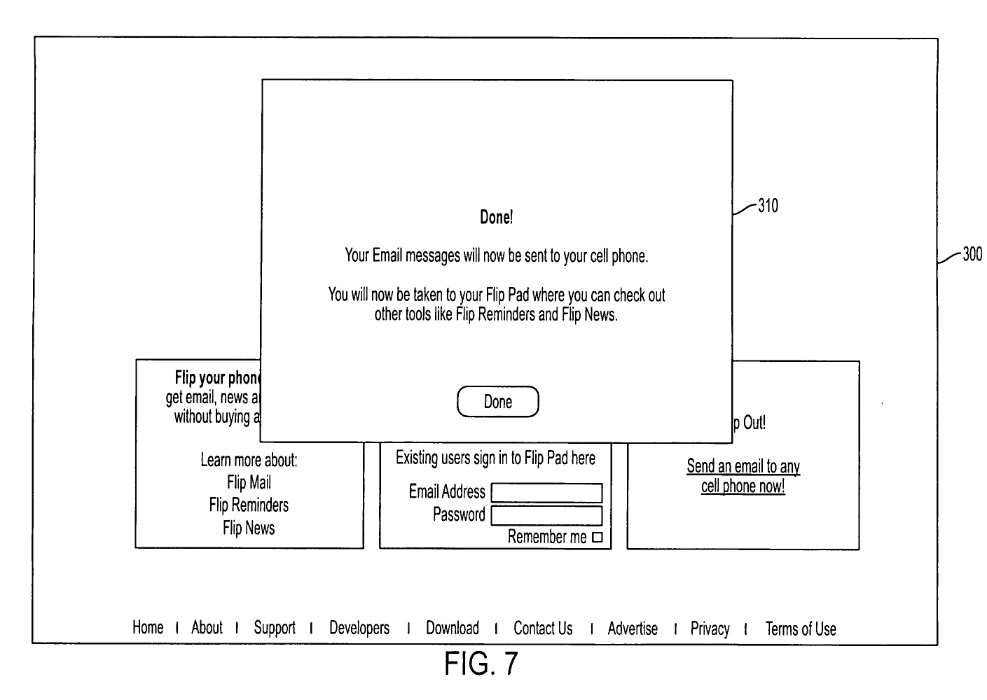

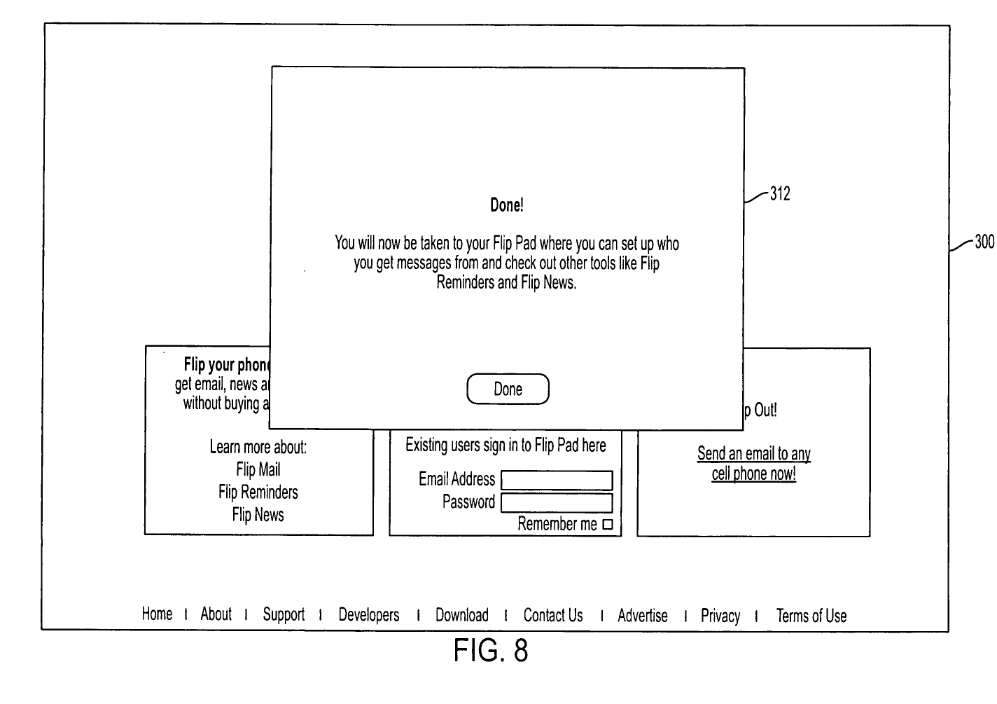

After step 212, the setup is complete, and a window 308 as shown in FIG. 6 is displayed. When the user chooses the “flip all my messages” option, a window 310 as shown in FIG. 7 is displayed, and when the user clicks on the “done” button, the process can direct the user to the “My Flip Pad” page window in step 214, as discussed in more detail below. Alternatively, when the user chooses the “let me choose” option, a window 312 as shown in FIG. 8 is displayed, and when the user clicks on the “done” button, the process can direct the user to the “My Flip Pad” page window in step 214, as discussed in more detail below.

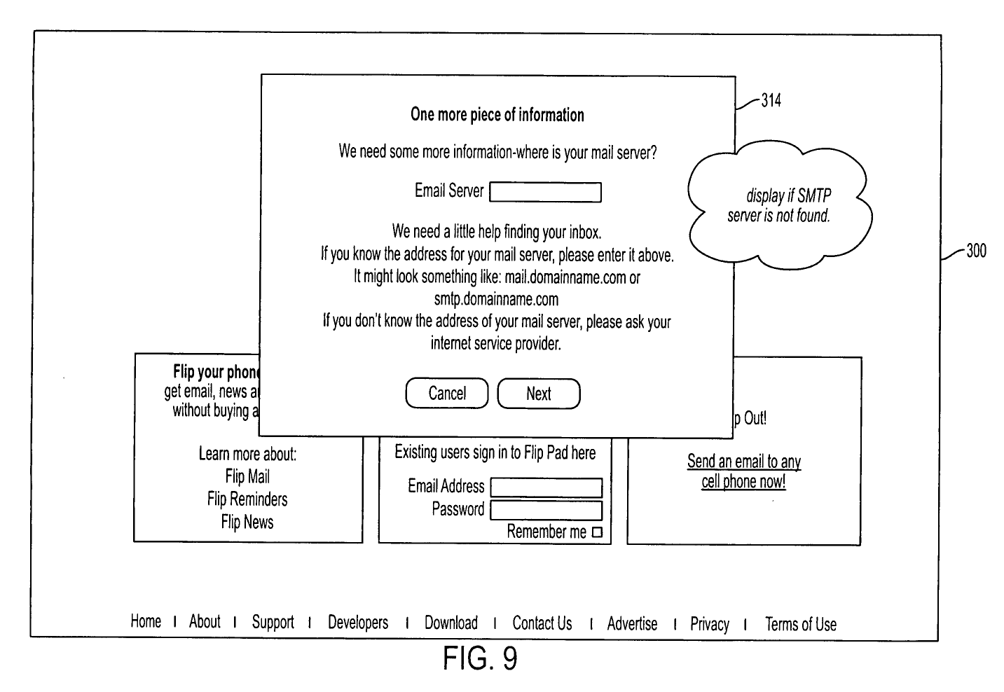

However, if in step 208, the user decides not to set up telemail, the user is directed in step 216 to the “My Flip Pad” window as discussed in more detail below. Also, if the process has difficulty in determining the SMTP server for the user's email, in step 218 the processing will display another window 316 is displayed as shown in FIG. 9, which requests the user to enter the email server name as indicated.

In step 220, the manual setup is complete, and a window 308 similar to that shown in FIG. 6 can be displayed, allowing the user to select the “flip all my messages” or “let me choose” options as discussed above. However, if the user still has difficulty with the manual setup, the processing instead proceeds to step 222 where a failure indication window (not shown) is displayed allowing the user to request technical support. The user can also selection an option on the failure indication window requesting to be directed to the “My Flip Pad” page.

In addition, once the account configuration succeeds, the server 18 (e.g., Apache server) stores the verified account information in, for example, a TFMain file and can display other web pages for contact management, such as an “Add Your Friends” page (not shown). The user can enter one or more email addresses into the Enter Email Contacts form on the Add Your Friends page. These addresses constitute the flipMail account's white-list, those email addresses from which flipMail will flip the email. Other email arriving at the email account will not be flipped. The server (e.g., server 18) validates the syntactic correctness of the entered email addresses, creates a nickname for each contact (used when the flipMail account owner wants to reply to a flipped email received on the mobile phone), stores the contact information in the TFMain file, and can display, for example, a “Manage Your Contacts' form (not shown) on the Add Your Friends page. In the Manage Your Contacts form, the user can optionally add more contacts and click an Add button, and modify contact nicknames and/or select contacts to delete, and then click an Update button. Each time the user clicks Add or Update, the server stores the updated information in the TFMain file.

When the user has finished modifying the contact list, the user can click a Next button. The server (e.g., Apache server) contacts the JBoss server instructing it to run the TMControl servlet that turns on mail flipping. The server can then display, for example, a “Tell Your Friends” page (not shown), which gives the user the opportunity to send to each address on the white-list an invitation to create a flipMail account. On the Tell Your Friends page, the user can customize the text of the invitation, and unselect white-list contacts so that they will not receive invitations. When the user clicks a “Done” button, the server 18 stores the invitations list in the TFMain file unless all names on the white list are unselected. The server 18 then can display a “Congratulations” page. The account creation process is thus complete, and the user can choose to further manage the account if desired as discussed below.

It should also be noted that a short time after the flipMail account is created and activated, a Job Processor, which is a separate server that runs periodic tasks, will query the JBoss server to retrieve any invitation lists containing addresses that need to be sent Tell Your Friends email messages, and, if any are found, will start the process of sending the messages The Tell Your Friends email sending task is deferred to the Job Processor rather than being performed by the server so that the new flipMail user does not have to wait while the messages are created and queued for sending before leaving the account creation pages.

Also, most of the available flipMail settings are established when the user first registers for a flipMail account. Registered flipMail users can change settings by accessing the Control Center on the web site; note that the Control Center page is the page that new users land on when they finish the registration process, as described above. To get to the Control Center at any time following account creation, users can visit the web site and sign in, using the mobile phone number and password they specified when they registered.

The Control Center can divide the settings it offers into, for example, two groups: FlipMail settings and Account settings. The FlipMail settings concern themselves with the email account that is flipped to the mobile phone. In this example, there are the following FlipMail settings users can configure:

Add/Manage friends: This presents a version of the Manage Your Contacts form that users see on the Add Your Friends page. When the user clicks Add or Save (which replaces the Update button displayed during account creation), the Apache Server updates TFMain.

Email Account settings: This setting presents a form on which the user can change the email account that gets flipped, or change the password used to access the current email account. The user clicks Save, which results in the Apache server storing the changes in TFMain. If the user has changed the email account, the server runs the auto-configuration script (along with requesting additional information, if necessary) before storing the changed setting in TFMain.

Email on/off/scheduling: Users can schedule when email flipping is active and when it is not. Users can select whether flipping is Always On, Always Off, or Scheduled On/Off independently for Weekdays and for Weekends. If Scheduled On/Off is chosen, users can specify the time of day to turn flipping on and the time of day to turn flipping off. After making changes, the user clicks Save. The server records the changed settings in TFMain. If flipping is being turned on, the server also instructs JBoss to run TMcontrol to implement the change.

Email message length: The user can choose how many fliplettes (e.g., 160 character chunks but this is carrier dependent) to use when flipping lengthy emails. Each fliplette arrives as a separate SMS message. Users can choose, for example, from between 1 and 10 fliplettes, with the default setting being 3. When the user clicks Save, the Apache server records the changed setting in TFMain.

Also in this example, there are the following Account settings:

Change Password: This changes the password users enter when they log in to their accounts on the web site. Users enter the current password and the new password (the latter twice, for verification, as the password is not echoed in readable form to the screen). When the user clicks Save, the server (e.g. Apache server) records the changed password (in encrypted form) in TFMain.

Change phone number: This setting changes the mobile phone number to which email is flipped; it also changes the number users enter when logging into the website. Users enter the current number, the account password, and the new number. The server 18 records the proposed change in TFMain, sends an email message to the user's email address that the phone number for that email account has changed, and displays a success message on the page.

Change time zone: A user can change the time zone associated with the mobile phone so that email delivery scheduling corresponds to the user's specified location. The available time zones are those for the geographic regions that the system services (currently the United States and Canada). The user selects the appropriate time zone and then clicks Save. The server stores the change in TFMain.

Cancel account: The user can delete the account. This operation requires confirmation, and, when confirmed, the server deletes all user information from TFMain.

The following management windows can also be accessed.

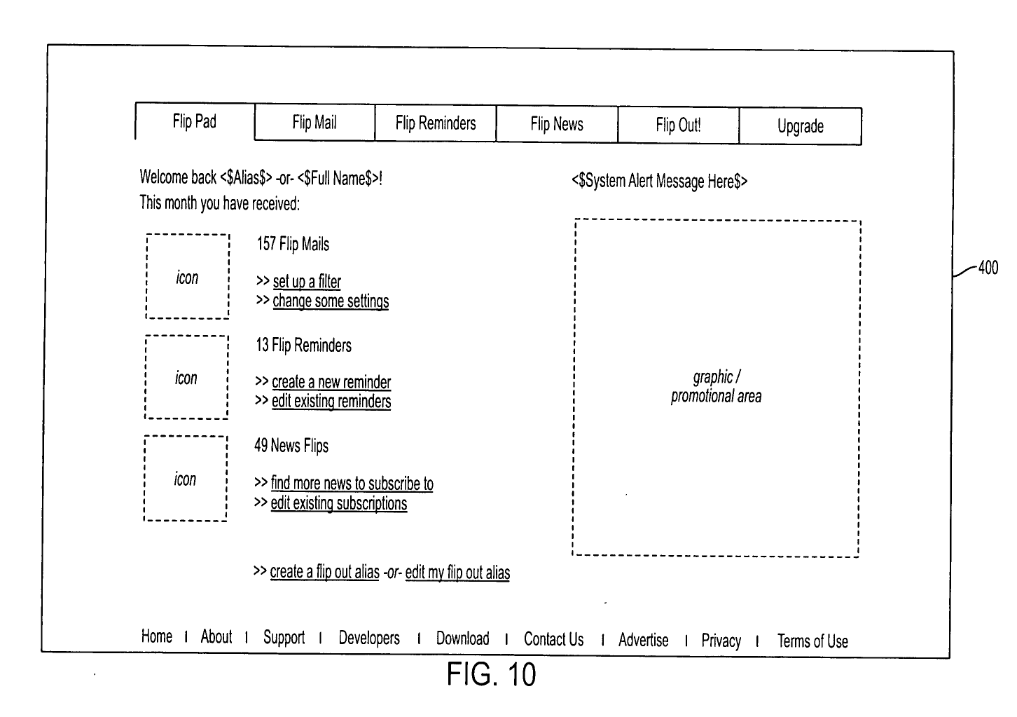

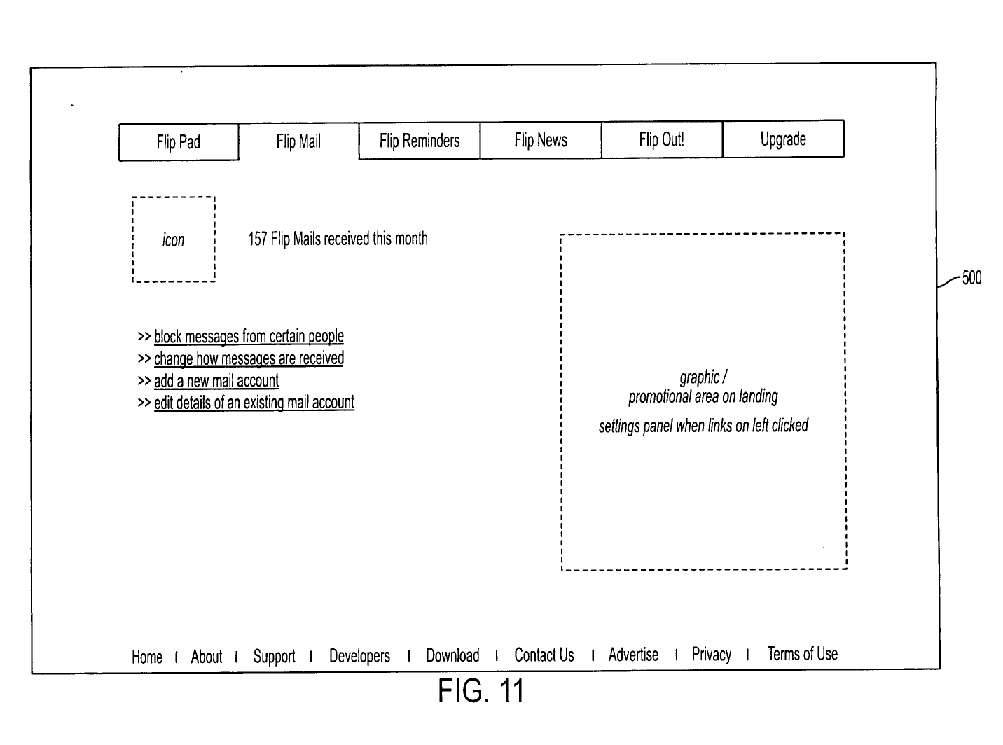

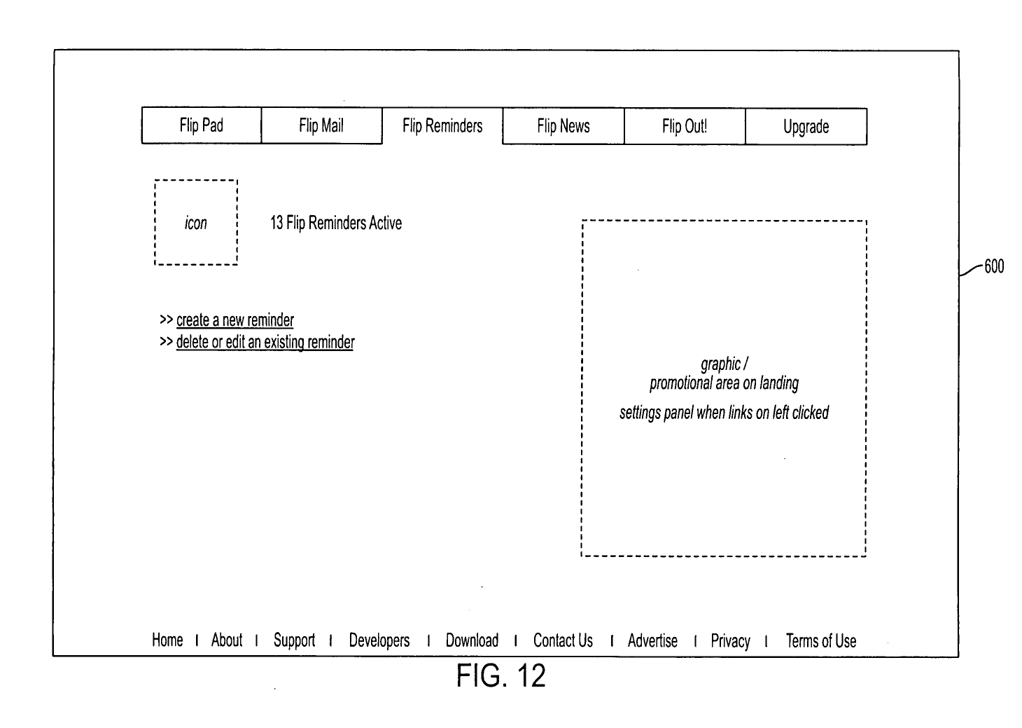

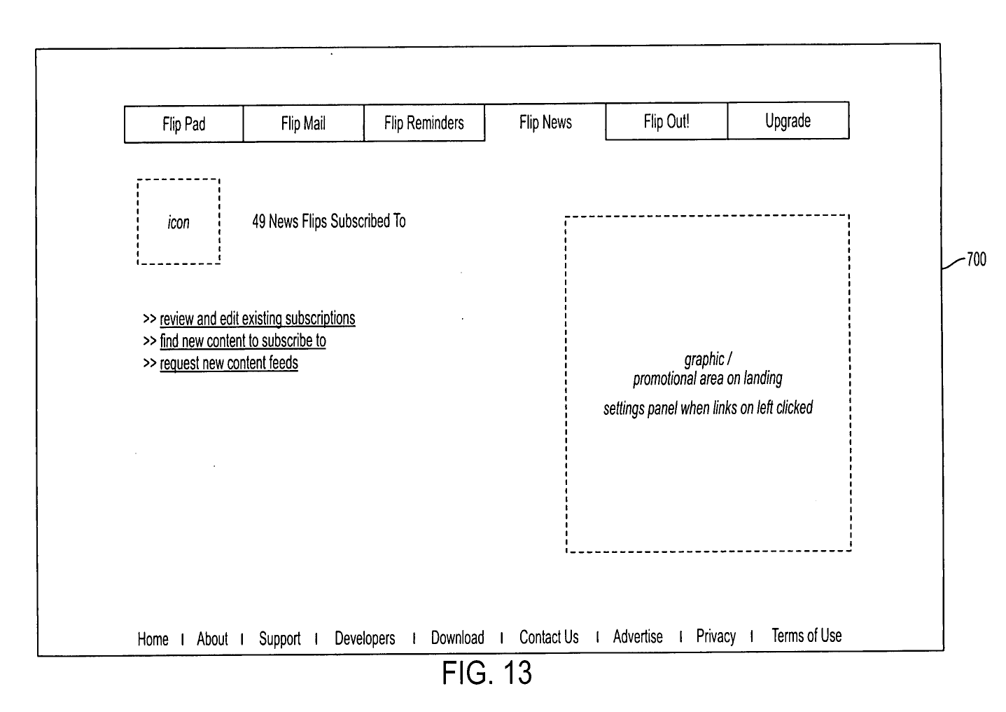

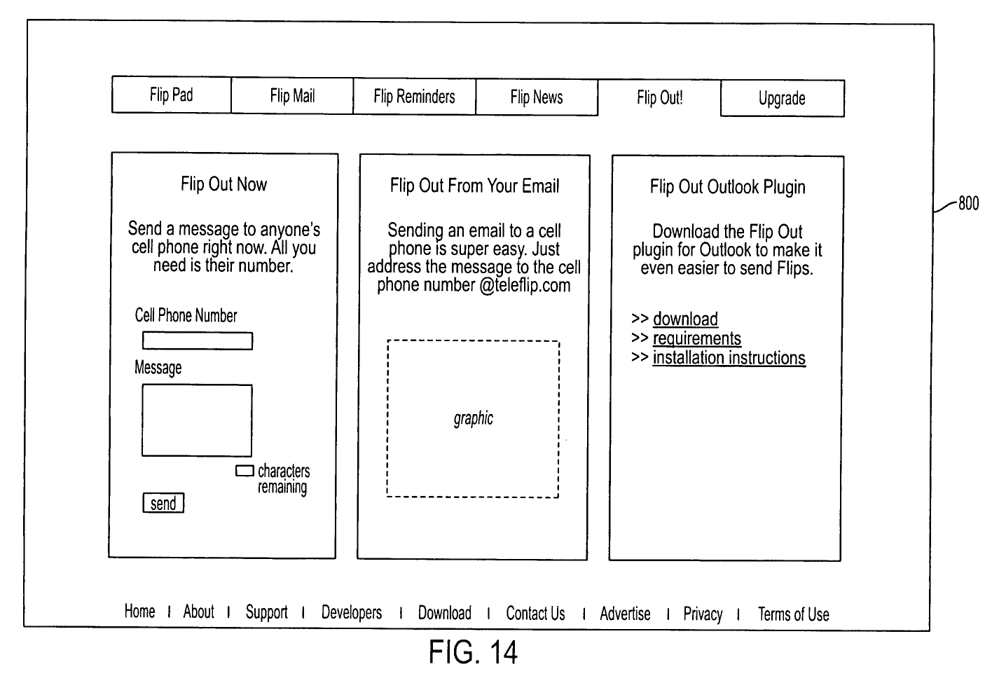

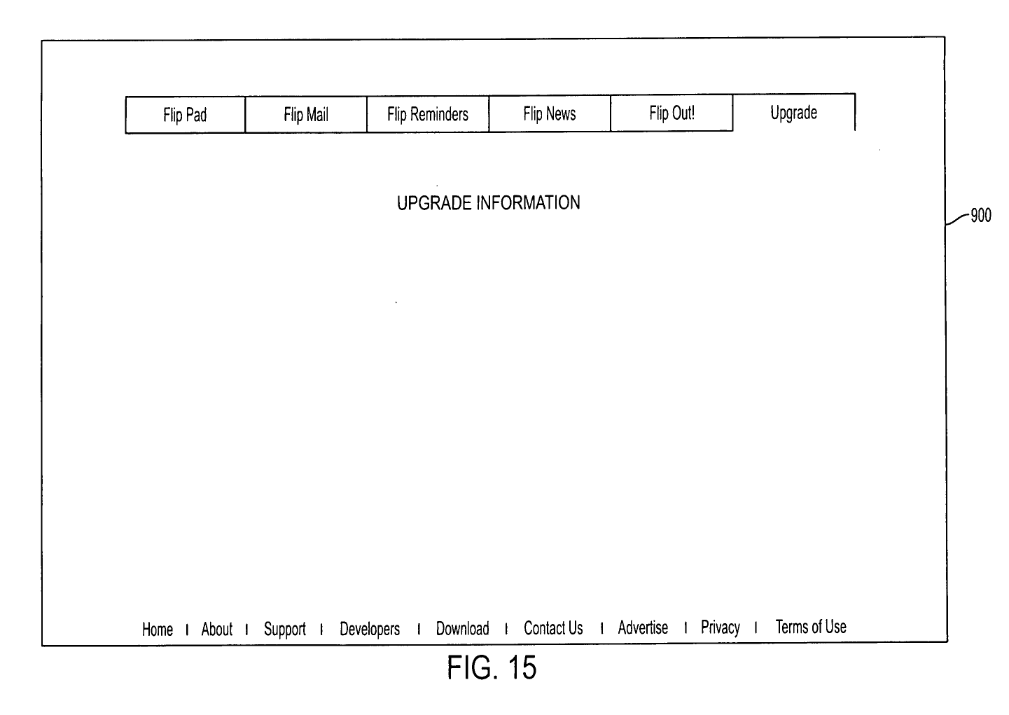

An example of a “My Flip Pad” window 400 is shown in FIG. 10. As shown, when a user logs in and accesses his or her “Flip Pad” window 400, the window displays information pertinent to the user's account, such as the number of mail messages received, the number of reminders received, the number of news messages received, and so on. The tabs 402 at the top of the web page allow the user to access other pages as shown in FIGS. 11-15. For example, the user can access the “Flip Mail” page 500 which, as shown in FIG. 11, includes information and commands relating to mail messages. The user can access the “Flip Reminders” page 600 which, as shown in FIG. 12, includes information and commands relating to reminder messages. Also, the user can access the “Flip News” page 700 which, as shown in FIG. 13, includes information and commands relating to news messages. In addition, the user can access the “Flip Out” page 800 which, as shown in FIG. 14, includes information and commands relating to sending messages as discussed in more detail below. Furthermore, the user can access the “Upgrade” page 900 which, as shown in FIG. 15, allows for changes and upgrades to the “Flip Mail,” “Flip Reminders,” and “Flip News” services discussed above.

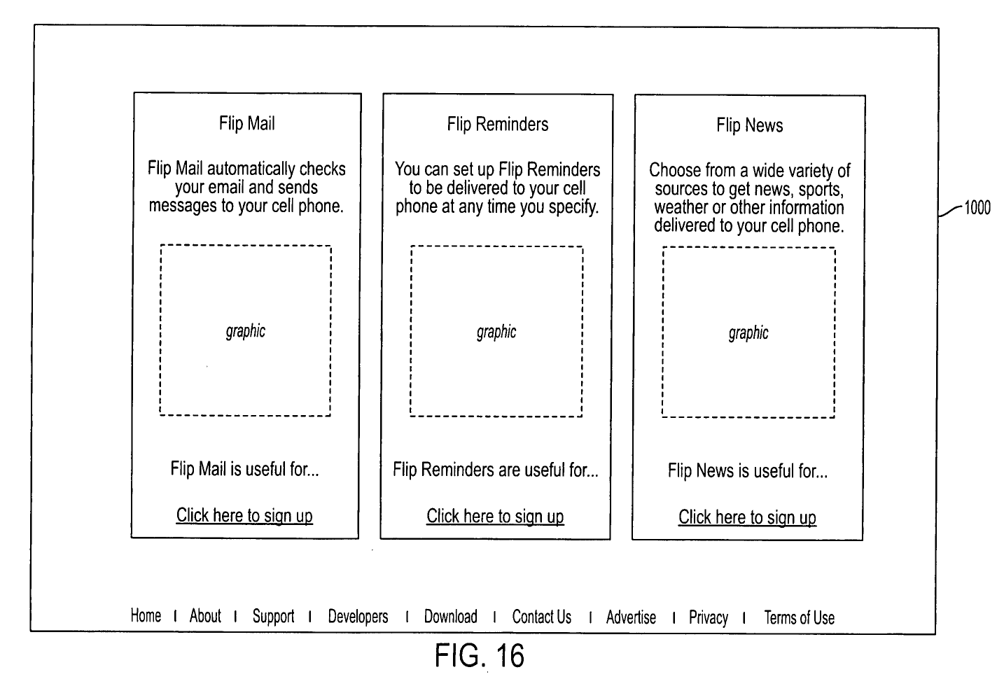

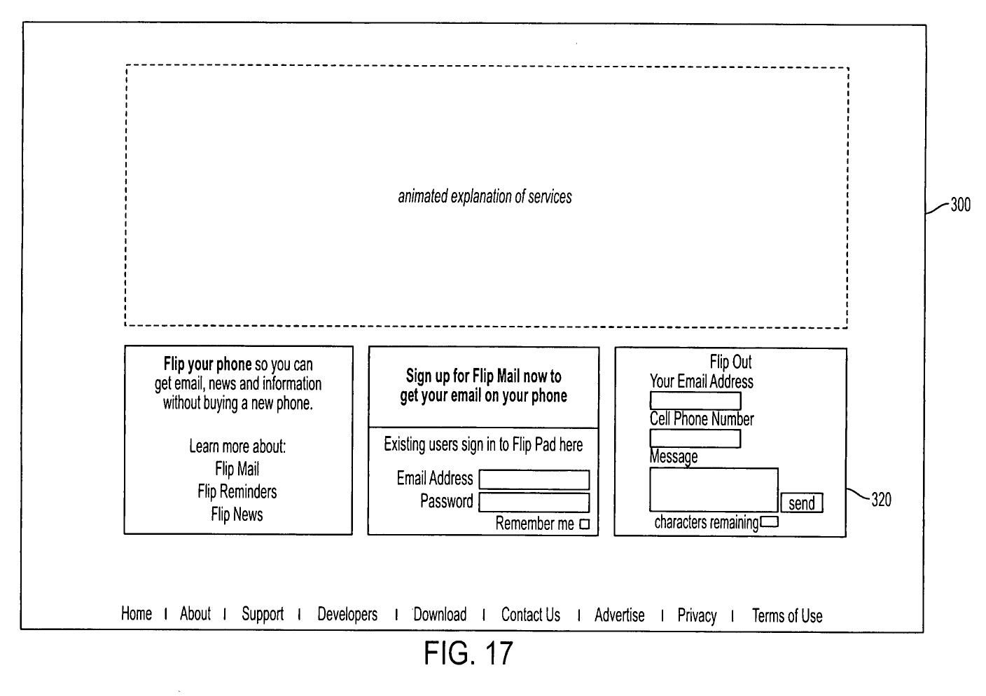

Furthermore, if the user clicks on the “Learn More” button 316 in the window 300 (see, e.g.,. FIG. 3), an information, window 1000 can be displayed which provides additional information and links to additional information as shown in FIG. 16. Also, if the user clicks on the “Flip Out” button 318 in the window 300 as shown in FIG. 3, a Flip Out window 320 can be displayed in window 300 to allow the user to send a message to a cell phone as indicated by entering the user's email address, the phone number to which the message is to be addressed, and the text of the message.

Thus, as can be appreciated from the above, the user can access the website to configure the management of message forwarding to the user. For example, the user can forward messages having or meeting the following particular attributes/conditions/filters: time of day (or range of time of day), the maximum message size/length, the message type, the number of messages per time period, the number of messages to be forwarded in a sequential block (e.g., no more than 20 messages sequentially in a block), the time delay between forwarding blocks of messages (e.g., 30 minutes), the senders, messages with or without attachments, the subject matters, keywords within the messages, and so on.

As will be appreciated from the following, the embodiments of the present invention described herein provide use, for example, SMS as a delivery mechanism rather than using the Internet/email (data), which thus allows the user to have email transmitted from his or her email account or accounts to his or her cell phone or other device, using SMS text as the means of receipt, rather than using the Internet/email (data). Also, alerts and other information (e.g., news, sports scores, etc.) can be transmitted and received in the same way, as specified by the user utilizing the website to set up the delivery as described above. Thus, costs to the user can be reduced, since the user would not need to sign up for data services with the user's carrier.

As will further be appreciated from the following description, the embodiments of the present invention can employ a sequencing methodology to take emails sent to the recipient, break them into chunks having a certain amount of characters (e.g., 150 characters per chunk), and make the messages appear to be one document rather than several SMS messages. The embodiments also provide the ability to link information to facilitate the user in associating and reviewing the messages in a group that belongs to the same message by, for example, append a header and/or trailer to each chunk. For example, if there are 4 chunks of messages broken from a long message, the embodiments of the present invention may be configured to provide a header “1 of 4”, “2 of 4” “3 of 4” and “4 of 4” for each chunk in a group. Further, the embodiments may provide alphanumeric message identifiers to distinguish between groups of message chunks. (e.g., “A1 of 4” to “A4 of 4” for message A, and “B1 of 4” to “B4 of 4” for message B; or “1 of A4” to “4 of A4” for message A, and “1 of B4” to “4 of B4” for message B) and so on.

The embodiments of the present invention also provide a “pull mail on demand” functionality that, enables users to use SMS protocol to pull their mail to their cell phones. Alternatively or in addition, the system has a “push mail on demand” functionality that pushes messages to users via SMS protocol to their cell phones. Both functions may be made available to the users as options and preferences. Either or both pull and push functions may be configured with user preferences, filters, conditions, and attributes, based on delivery management or conditional delivery described herein.

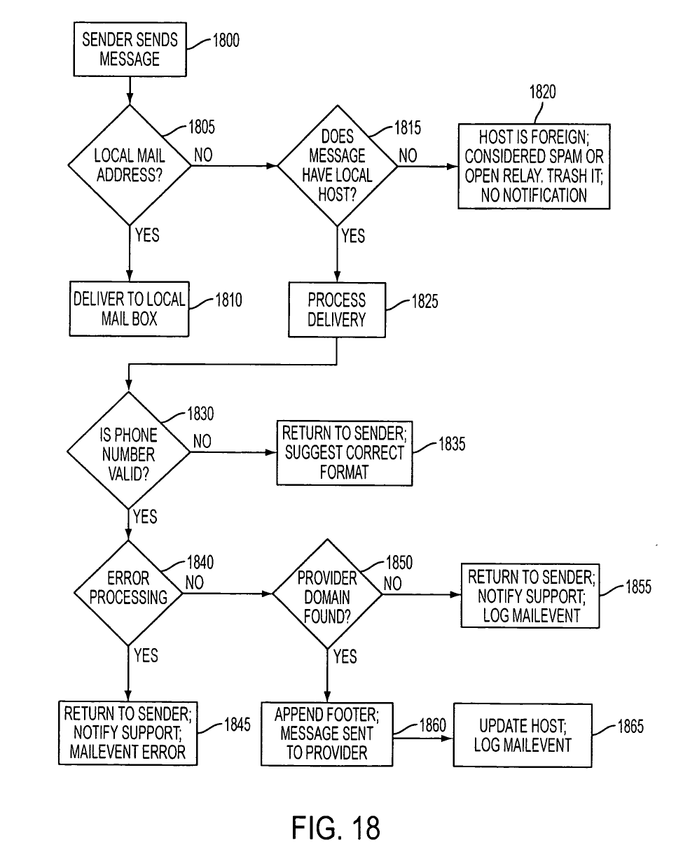

As described in U.S. patent application Ser. No. 11/053,528, and as shown in FIG. 18, an email can be sent using the telephone number followed by “@xxxxx.com” and the email will be forwarded to the correct domain name with the correct syntax necessary to reach the designated telephone. As shown in FIG. 1, a system and method according to embodiments of the present invention typically employ an email server coupled to a database 22 of telephone numbers and/or telephone number prefixes corresponding to the appropriate company providers and their domain names. When an email is received by the server 18, a program routine looks in tables or information in the database 22 to find either the designator prefix, or the telephone number in its entirety, and captures the corresponding OCN (Operating Company Number). The OCN can then be used to look up, e.g., search for, the corresponding domain name and syntax for that phone provider. The email is forwarded to the appropriate domain name necessary to reach the desired telephone.

Alternatively, the database 22 can store email addresses containing telephone numbers and/or telephone number prefixes, corresponding to the appropriate company providers and their domain names. When an email is received by the server 18, a program routine looks in the tables or information in the database 22 to find the recipient's email service provider correlating to the designator prefix (such as an “E”) and the recipient's telephone number in its entirety. If this information is contained in database 22, the email is forwarded to the appropriate domain name necessary to reach the desired email account.

These and other operations can be more fully appreciated with reference to FIG. 1, and the flowcharts and diagrams set forth in FIGS. 18-21, which are similar to those set forth in U.S. patent application Ser. No. 11/053,528.

As shown in FIG. 18, in step 1800, the sender device 10 attempts to send and e-mail message from computer (sender device 10) to message-capable phone, such as a cell phone (recipient device 14). The message can be addressed to: 1234567890@xxxxxx.com, where “1234567890” is the cell phone's area code and number. In step 1805, the message is received by the server 18, and the software run by the server 18 (i.e., “the software”) differentiates between a local mail address (e.g., an employee at company “xxxxxx” or any administrative recipient) and a cell phone number address. If the message has a local mail address, the mail is sent to the local recipient in step 1810. If, however, the address is a cell phone number address, the software determines in step 1815 whether the message has Local Host information (e.g., located in the header of the message). If the Local Host information is missing, the message is considered spam and in step 1820, the software discards the message, and no one is notified.

However, if it is determined in step 1815 that the message has Local Host information in the header, then the message proceeds through the message delivery process beginning in step 1825. That is, the software determines in step 1830 whether the phone number is a valid phone number. This is done by determining whether the address contains 10 digits corresponding to the cell phone's area code and number, and whether the area code and number are valid numbers. If the phone number is determined to be invalid, for any of the above reasons, the message is returned to the sender in step 1835, with a message suggesting the proper format for sending the mail.

However, if the number is valid, step 1840 is intended to catch any actual application errors that may happen during the mail processing, for example, if database connectivity is lost, or some other unexpected internal error occurs. If there is a technical problem with equipment, or other unexpected problem, a message is sent to the sender informing the sender that there is a problem in step 1845. In such a situation, the system administrator is also notified to proactively troubleshoot the problem.

If there is no error, the service takes the validated phone number, and queries the database 22 to find a matching mobile service provider domain name. That is, in step 1850, the processing basically takes the message address 1234567890@xxxxx.com, finds the corresponding phone provider (wireless or landline), based on the phone number, and then modifies the address to send on to 1234567890@providerX.com. If the processing does not find a matching mobile service provider domain name, either the phone number is incapable of receiving messages, or the database 22 does not have the corresponding provider information. In these cases, the processing notifies the sender in step 1855 that the email was not delivered go through because the database 22 did not have the number.

However, if the Provider Domain is found, the message is sent to the recipient's email account in step 1860 by attaching a footer to the message indicating that the message has been sent by the processing (e.g., by the server 18). In an alternative, the footer message can be an advertisement or commercial message. The message having either type of attached footer is forwarded to the provider's SMTP server. In step 1865, the software logs to a mail event file if the message was successfully forwarded to the correct provider.

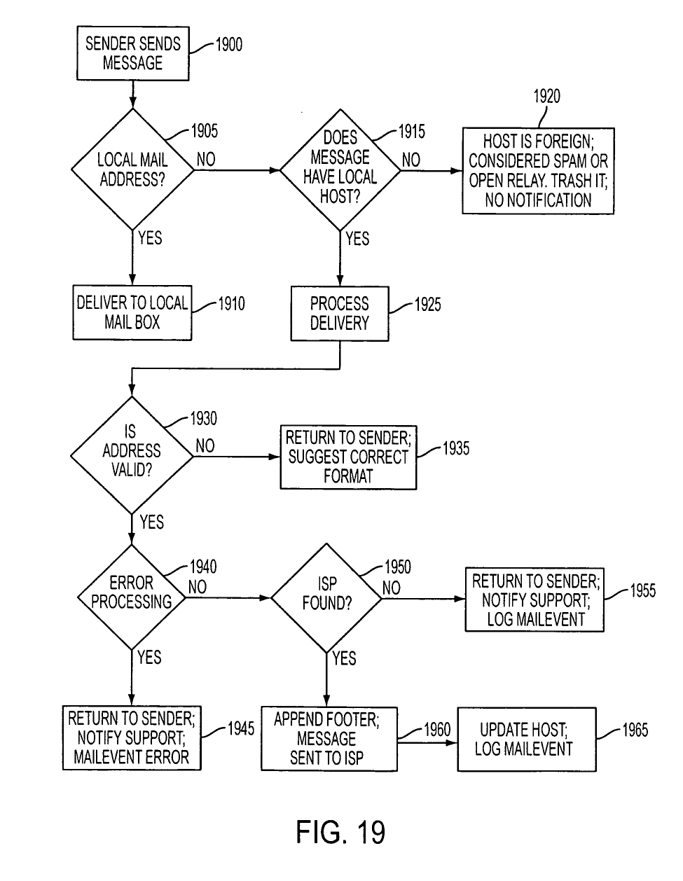

FIG. 19 is a flowchart illustrating an example of processing that can occur when the sender attempts to send an email message from a computer to another computer. In step 1900, the sender device 10 attempts to send and e-mail message from computer (sender device 10) to message-capable phone, such as a cell phone (recipient device 14). The message can be addressed to: E1234567890@xxxxxx.com, where “E1234567890” is the recipient's cell phone's area code and number, with the “E” appended to indicate that the mail is intended to be received by the recipient's computer email account. In step 1905, the message is received by the server 18, and the software run by the server 18 (i.e., “the software”) differentiates between a local mail address (e.g., an employee at company “xxxxxx” or any administrative recipient) and a cell phone number address. If the message has a local mail address, the mail is sent to the local recipient in step 1810. If, however, the address is a cell phone number address with an appended “E”, the software determines in step 1915 whether the message has Local Host information (e.g., located in the header of the message). If the Local Host information is missing, the message is considered spam and in step 1920, the software discards the message, and no one is notified.

However, if it is determined in step 1915 that the message has Local Host information in the header, then the message proceeds through the message delivery process beginning in step 1925. That is, the software determines in step 1930 whether the phone number has a leading “E” and is a valid phone number. This is done by determining whether the address contains 11 digits corresponding to the leading “E” and the cell phone's area code and number, and whether the area code and number are valid numbers. If the phone number is determined to be invalid, for any of the above reasons, the message is returned to the sender in step 1935, with a message suggesting the proper format for sending the mail.

However, if the number is valid, step 1940 is intended to catch any actual application errors that may happen during the mail processing, for example, if database connectivity is lost, or some other unexpected internal error occurs. If there is a technical problem with equipment, or other unexpected problem, a message is sent to the sender informing the sender that there is a problem in step 1945. In such a situation, the system administrator is also notified to proactively troubleshoot the problem.

If there is no error, the service takes the validated phone number, and queries the database 22 to find a matching mobile service provider domain name. That is, in step 1950, the processing basically takes the message address E1234567890@xxxxx.com, finds the corresponding phone provider (wireless or landline), based on the phone number, and then modifies the address to send on to E1234567890@providerX.com. If the processing does not find a matching mobile service provider domain name, either the phone number is incapable of receiving messages, or the database 22 does not have the corresponding provider information. In these cases, the processing notifies the sender in step 1955 that the email was not delivered go through because the database 22 did not have the number.

However, if the Provider Domain is found, the message is sent to the recipient's email account in step 1960 by attaching a footer to the message indicating that the message has been sent by the processing (e.g., by the server 18). In an alternative, the footer message can be an advertisement or commercial message. The message having either type of attached footer is forwarded to the provider's SMTP server. In step 1965, the software logs to a mail event file if the message was successfully forwarded to the correct provider.

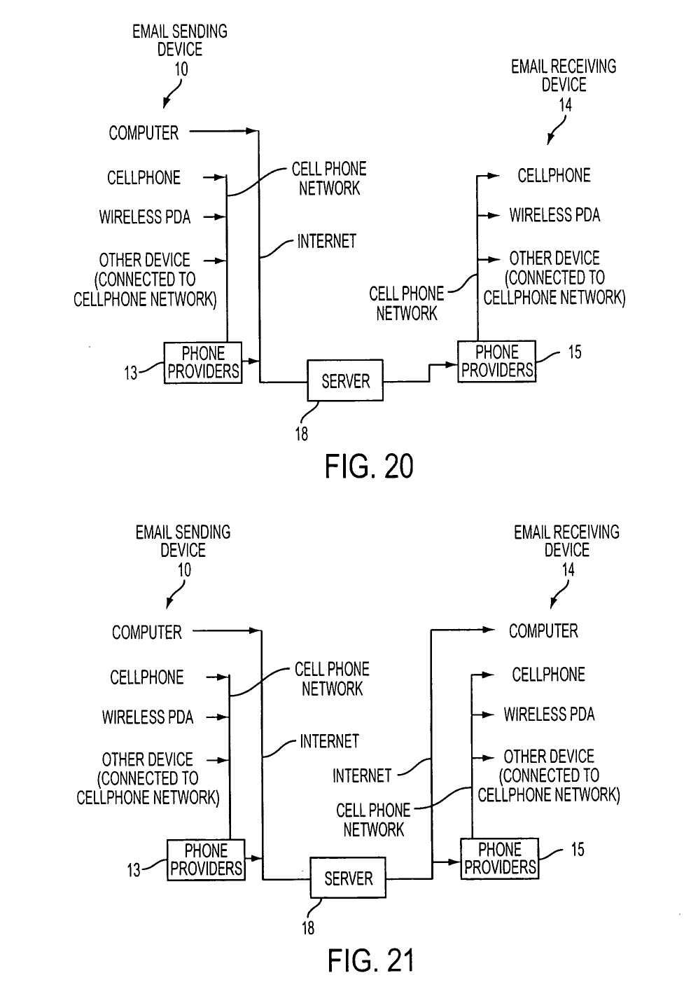

In simplified form, the message processing from sender's email to recipient's email combines all, or some groups of the following steps shown in FIG. 20, with further reference to FIG. 1. An email message 12 (see FIG. 1) is sent by a sender through a sender device 10 such as a computer, cell phone, wireless PDA or other device connected to the cell phone network. The message is addressed to 1234567890@xxxxx.com, where “1234567890” is the message-capable telephone's area code and number. When the sender device 10 is a computer, the email message 12 is transmitted through, for example, the Internet (e.g., network 16 shown in FIG. 1) to the server. When the sender device 10 is a cell phone, wireless PDA or other device connected to the cell phone network, the email message 12 is transmitted through the cell phone network to the appropriate phone provider 13.

The phone provider directs the message through, for example, the network 16 (e.g., the Internet) to the server 18. Upon receipt of an email message 12, the server 18 takes the validated phone number, and queries the database 22 to find a matching mobile service provider domain name. The server 18 (e.g., software running at or associated with the server 18) takes the message address 1234567890@xxxxx.com, finds the corresponding wireless provider based on the phone number, and then modifies the address to send on to 1234567890@providerX.com The server 18 forwards the message to the appropriate phone provider 15. The phone provider 15, upon receiving the message from the server 18, delivers the email message 12 to the recipient device 14, which could be a cell phone, wireless PDA or other device connected to the cell phone network, over the cell phone network.

Similar processing occurs when the recipient device 14 is a computer. However, as shown in FIG. 21, the server 18 forwards the message over, for example, the Internet to the computer's Internet service provider, for delivery to the receiving computer 10.

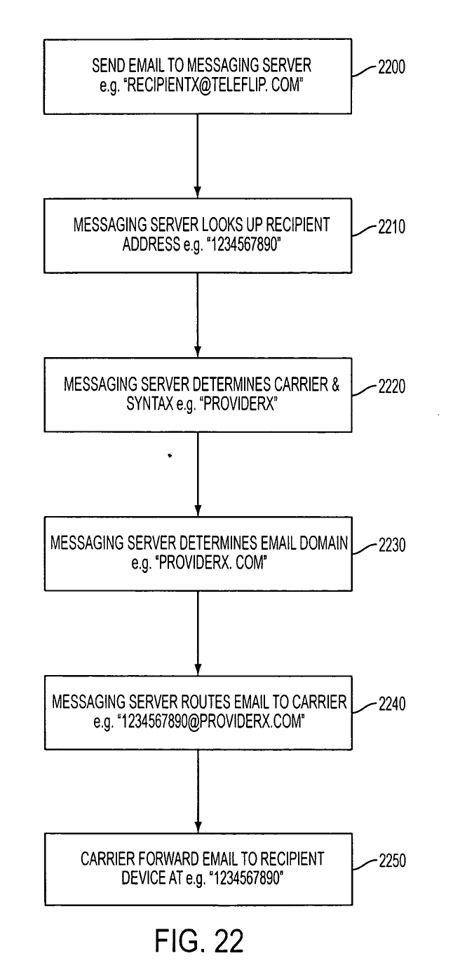

Further embodiments of the present invention are exemplified in FIGS. 22-24.

FIG. 22 is a flow diagram illustrating an example of operations involved in the process in accordance with this embodiment. As can be appreciated by one skilled in the art, these operations perform physical manipulations of physical quantities. Usually, though not necessarily, these quantities take the form of electrical or magnetic signals capable of being stored, transferred, combined, compared, and otherwise manipulated.

In step 2200, the sender 10 transmits the email message 12 via a data communications network 16 to a messaging server 18, along with the targeted recipient's alias address. The network 16 may include cellular networks, wide area networks such as the Internet, local area networks, telephony networks and PSTN's, or any other suitable network.

Useful devices for performing the operations of the embodiments of present invention described herein include, but are not limited to, general or specific purpose communication, digital processing and/or computing devices, which devices may be standalone devices or part of a larger system. For example, the messaging server 18 may be implemented as a unitary physical device, or a combination of several separate discrete physical devices operationally coupled together to form a functional messaging server, each with one or more dedicated functions. The devices may be selectively activated or reconfigured by a program, routine and/or a sequence of instructions and/or logic stored in the devices, and the methods described and suggested herein are not limited to a particular processing configuration.

Also, in this embodiment, the alias may be a unique identifier specific to the recipient's device, and which is an unique identifier across carrier network platforms (i.e., network independent), such as a cellular phone number, as disclosed in co-pending U.S. patent application Ser. No. 11/053,528 and discussed above. Such identifier is used to construct the email address with the correct syntax associated with the recipient's wireless network carrier's email platform. Also, the alias may be an alphanumeric representation of an identifier, such as a nickname associated with the recipient which is easy to remember by the sender (e.g., “recipientx”). The sender device 10 would simply address the email using a universal or generic domain applicable to the messaging server, such as “xxxxx.com” (i.e., recipientx@xxxxx.com). The network 16 may include wired and/or wireless network, such as cellular network, telephony network (e.g., Public Switched Telephone Network (PSTN)), data network (e.g., T-1; DSL), Internet, or other types of data and/or communications networks. The sender 10 may specify more than one recipient (e.g., Recipient X, Recipient Y, etc.) for the same email message, which is well within the scope and spirit of the present invention.

Turning back to the flowchart in FIG. 22, in step 2210, the messaging server 18 looks up the corresponding unique addressing identifier or recipient device identifier (in this case the cellular telephone number; e.g., “1234567890”) associated with the alias of the recipient, by accessing an alias table 20, or any other suitable record, in the database 22. The association of the recipient and the particular alias is pre-assigned by the user, which may be the recipient 14 or sender 10, or both with different aliases to suit their individual conveniences, preferences and ease of use. Such user accesses the alias table 20 via a suitable interface to the messaging server 18 (e.g., web access to the messaging server, or text messaging the alias assignment to the messaging server). In the case when the user is the recipient 14, the user recipient can pre-assign a number of aliases for each of his or her devices using which she receives messages (e.g., Device A to Z; a different alias for a different cell phone or other wireless devices). In the case when the user is the sender 10, she can pre-assign a number of aliases for many persons (e.g., Recipient A to Z), including several aliases for a single person which are associated with various receiving devices for that particular person (e.g., a different alias for a different cell phone or other wireless devices). The sender 10 notifies the alias(es) to his or her associates from whom she is interested in receiving messages.

In step 2220, the messaging server 18 then determines the corresponding wireless network carrier (e.g., ProviderX) that services the recipient's particular cellular phone number, and the appropriate wireless network dependent syntax for email messaging to the recipient, using a process such as that disclosed in the co-pending U.S. patent application Ser. No. 11/053,528. Information concerning the recipient's carrier may be maintained at a carrier table 24 (e.g., containing NPAC data) in the database 22. In step 2230, the messaging server 18 then determines the carrier dependent email domain associated with the particular carrier (e.g., “providerx.com”).

That is, the carrier table 24 in this embodiment contains telephone number assignments to various cellular network carriers, independent of participation in the database by the carrier's customers (i.e., customers do not need to actively participate in the database by setting their own email address, since the database merely contains information relating phone numbers to cellular phone carriers as dictated by the carriers, whether or not a particular number has been assigned to a particular customer). Accordingly, the sender only needs to know the recipient's assigned alias unique cellular phone number as identification, and the syntax of the email domain for emailing the designated email server. Senders can quite easily remember the email domain for the designated server, as it could be a single email domain (e.g., xxxxx.com) that is universal or generic to a large number of recipients under various cellular carriers, to thereby take advantage of the universal message forwarding service to recipients at disparate networks. By accommodating use of an alias, it improves ease of addressing by the sender, without the inconvenience of remembering and entering the recipient address identification and carrier dependent email syntax. Further details of various processes and variations thereof involved in the delivery of email messages to recipients, based on recipients' wireless phone numbers and a generic email domain, are disclosed in co-pending application Ser. No. 11/053,528. The embodiment of the present invention also provides a further level of ease of email addressing by allowing for the use of an alias in place of the wireless phone number.

Returning to FIG. 22, in step 2240, the messaging server 18 forwards the sender's email message (which may include only message content, or with applicable header information) to the recipient's carrier 26 (e.g., to the carrier's SMTP or SMS messaging server owned and/or managed by the carrier, or contracted to be managed by a third party) via network 16 (or in the alternate via another network 28 separate from network 16), using the phone number and the carrier dependent email syntax (e.g., 1234567890@providerx.com). In step 2250, the email message is delivered to the recipient device 14 as a SMS text message by the carrier 26 via a wireless network 28, which may or may not be a part of the network 16, and in this example is a cellular network.

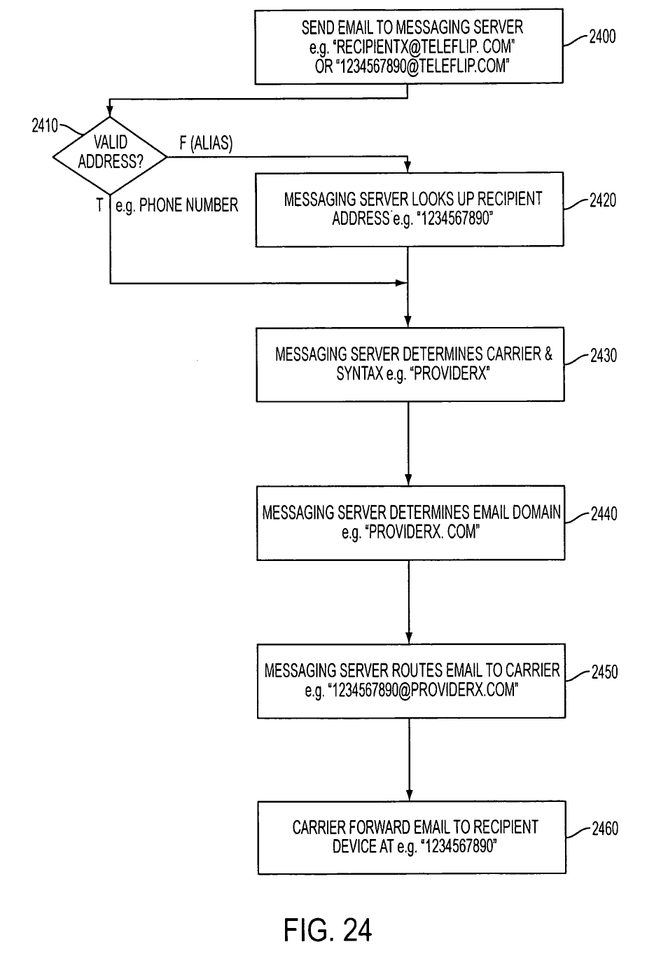

In addition, or in the alternative, the messaging server 18 may be configured to handle emails that are addressed based on recipients' unique address such as cellular phone number, and recipient's alias. For example, in step 2400 in the flowchart shown in FIG. 24, sender addresses an email either based on an alias (e.g., “recipientx”) or recipient address identifier (e.g., cellular phone number “1234567890”), and the generic email domain of the messaging server (i.e., xxxxx.com). In step 2410, the messaging server 18 determines whether a valid phone number or an alias is being used in such address. If an alias exists, in step 2420, the messaging server 18 looks up the recipient's address identifier from the alias table 20, as in the embodiment described above with regard to FIG. 22, and the messaging server 18 determines in step 2430 the associated wireless carrier and email syntax based on the phone number in a manner similar to that described above with regard to step 2220 in the flowchart of FIG. 22. However, if the address is not an alias but a valid phone number, the processing proceeds directly to step 2430.

The remaining steps involved to forward the email are similar to those described above with regard to FIG. 22. That is, in step 2440, the messaging server 18 then determines the carrier dependent email domain associated with the particular carrier (e.g., “providerx.com”). In step 2450, the messaging server 18 forwards the sender's email message (which may include only message content, or with applicable header information) to the recipient's carrier 26 (e.g., to the carrier's SMTP or SMS messaging server owned and/or managed by the carrier, or contracted to be managed by a third party) via network 16 (or in the alternate via another network 28 separate from network 16), using the phone number and the carrier dependent email syntax (e.g., 1234567890@providerx.com). In step 2460, the email message is delivered to the recipient device 14 as a SMS text message by the carrier 26 via a wireless network 28, which may or may not be a part of the network 16, and in this example is a cellular network.

In addition, the sender may have access to an address book stored on the messaging server 18, to establish the aliases for the sender's contacts. The contact information can include, but is not limited to, cellular phone numbers. A sender may also choose to create his own alias to be sent to the recipient, so that the recipient may use that alias for future email communication with the sender. The email 12 sent using the process and system disclosed herein may include attached files, which may include, but is not limited to, analog and digital voice messages, text files, image files, executable files, music files, audio files, video files, multimedia files, and so on. A data file such, as a text message, can be created by the messaging server 18 converting a voice message into the text message. In this example, a voice message is provided to the messaging server 18 via the sender device 10 and the voice message is converted to a text message using, for example, a speech-to-speech conversion process as known in the art.

A sender may also group a number of recipients into a distribution list with an assigned alias, where the sender need only select an alias for the distribution list, to send an email to each member of the distribution list. The messaging server 18 would determine from the alias table 20 the associated addresses of each member, and the corresponding network carriers and email syntax, which may be different for different members of the distribution list. Each member of the distribution list may have different types of recipient devices, which may be supported by different network carriers. Also, a distribution list with an alias may be created for sending an email to multiple devices of a particular recipient.

Also, when the recipient device 14 comprises a VoIP device, the sender device 10 may send an email to the recipient VoIP device by addressing to the messaging server 18 using an alias assigned to such phone number, which email is then forwarded to the appropriate VoIP carrier based on the phone number, which is rerouted by the carrier to the recipient based on the unique IP address associated with the phone number, involving steps similar to those described above in connection with FIGS. 22 and 24.

It should be noted that as discussed above with regard to FIGS. 3 and 14 in particular, a user can use the “FlipOut” service to send an email message. In doing so, the user composes the email message using any available email client. The user addresses the message to, e.g., 1234567890@xxxxx.com, as discussed above, where “1234567890” represents the recipient's ten-digit mobile phone number comprising a seven-digit number pre-pended by a three-digit area code. The user can send the message via the user's normal Internet email service provider. Typically, within minutes, the message arrives at the recipient's mobile phone as an SMS text message as a result of the processing described above with regard to, for example, FIGS. 18-22 and 24. The received message contains the sender's email address, the message's subject line, and as much of the message itself as will fit within the remainder of 160 character limit allotted to a standard SMS message.

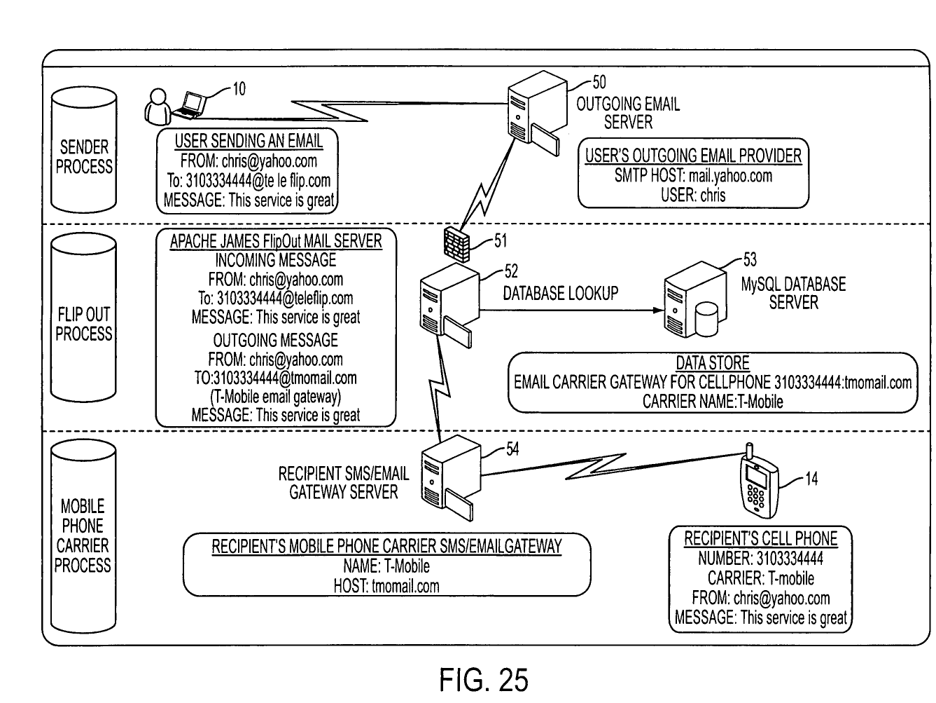

This process is further illustrated in the diagram shown in FIG. 25. It is noted that the servers and databases discussed below can have characteristics and operability similar to those of the servers and databases (e.g., server 18 and database 22) as discussed above. Likewise, the sender and recipient devices discussed below can have characteristics and functionality similar to that of those discussed above.

As shown in FIG. 25, the user composes an email message from any available email client and addresses the message (e.g. 3103334444@xxxxx.com). The user uses the sender device 10 to send the message using their email service provider via, for example, the Internet. The email message passes through the open source firewall 51 and arrives at the server 52 (e.g., the “Apache James FlipOut Mail Server”, hereinafter referred to as “James”) which runs various Java matchers and mailets that handle flipOut email messages. James extracts the destination phone number from the email address., and a matcher running on James performs a database lookup on database 53 and returns the mobile phone carrier information associated with the phone number and the carrier's SMS/email gateway information. If the phone number is not found or the carrier information does not contain the required gateway information, then the message is discarded as discussed above.

A mailet running on James extracts the email message text, the sender's email address, and the subject line and prepares an email to be sent via the carrier's SMS/email gateway 54 to the recipient's mobile phone (e.g., recipient 14). The SMS character limit is carrier dependent. Therefore, any portion of the SMS text message whose characters exceed this limit will be, for example, truncated. James sends the email message to the mobile phone carrier's SMS/email gateway via, for example, SMTP. The final delivery of the message is left to the mobile phone provider's SMS implementation.

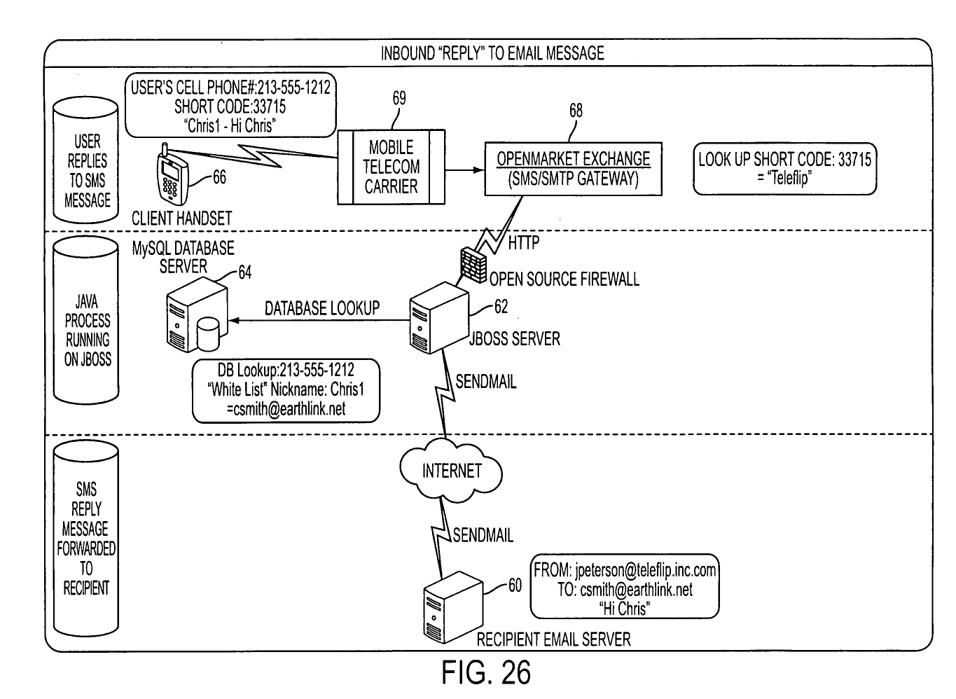

As discussed above, when a flipMail user receives a flipped email, the message comes as an SMS message. Any reply a user makes is sent back as, for example, an SMS message. Converting that reply into an email message and routing it back to the original sender uses the following exemplary process, which is illustrated in FIG. 26. Again, the servers and databases discussed below can have characteristics and operability similar to those of the servers and databases (e.g., server 18 and database 22) as discussed above. Likewise, the sender and recipient devices discussed below can have characteristics and functionality similar to that of those discussed above.

The user composes a reply to the message, beginning the reply with the original sender's nickname (which was provided in the message). Note that begins the reply with the nickname in order for flipped mail replies to reach their destinations. The user, via recipient server 60, for example, sends the SMS reply, which by SMS protocol includes the short-code from the original SMS message. The mobile phone provider examines the short-code and determines who routed the original SMS message. The mobile phone provider sends the reply to the third-party service (e.g., OpenMarket Exchange) from which it received the original message.

The third-party service looks up who owns the short-code. The third-party service uses the HTTP POST protocol to send the converted message to a servlet running on the JBoss server 62. The servlet unwraps the message, and notes the phone number of the mobile phone from which the reply originates. The servlet also extracts the embedded nickname from the beginning of the reply's contents. The servlet queries the database 64 for the white-list associated with the phone number. The white-list includes the nickname for each email address on it. The servlet finds the entry in the white-list that corresponds to the nickname embedded in the reply, and uses the email address associated with the nickname as the To: address for the reply email. The servlet obtains the email address associated with the user's flipMail account and uses that as the From: address of the reply email. The servlet places the contents of the reply into the email's body and sends the repackaged and readdressed reply as an email to the client handset 66 (recipient device) via, for example, an open market exchange 68 and mobile carrier 69 using, for example, normal Internet protocols.

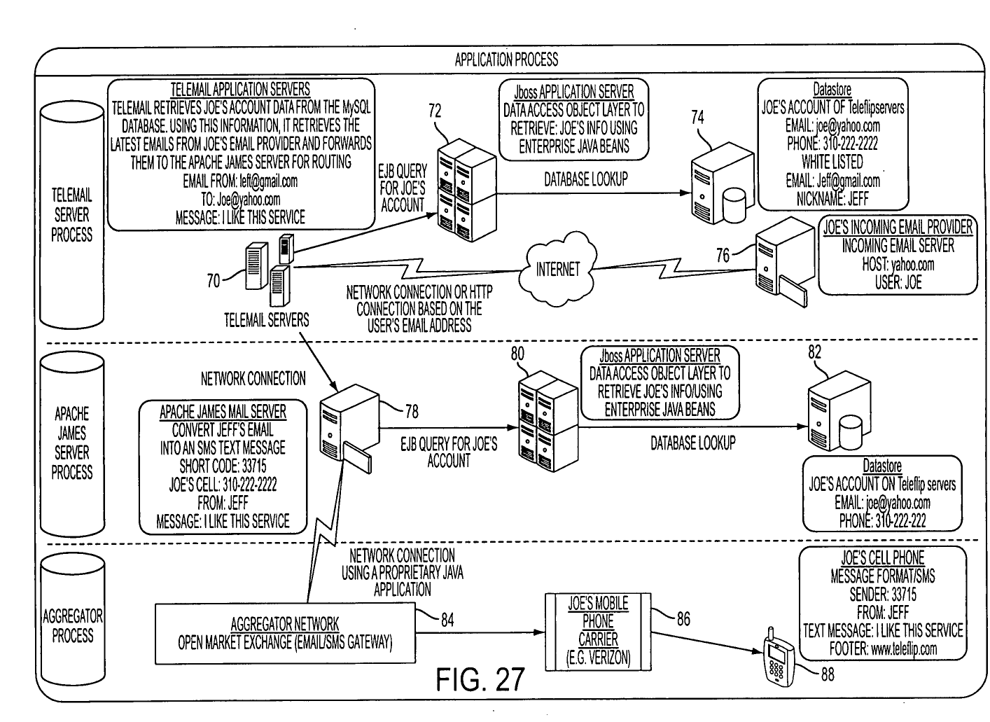

In addition, based on the user's flipMail settings (settings that dictate which emails the user wishes to have forwarded to their mobile phone according to their scheduled times), the following process, viewed with the diagram shown in FIG. 27, describes how these incoming email messages are converted to SMS-compatible form and forwarded on to the user's specified mobile phone. Again, the servers and databases discussed below can have characteristics and operability similar to those of the servers and databases (e.g., server 18 and database 22) as discussed above. Likewise, the sender and recipient devices discussed below can have characteristics and functionality similar to that of those discussed above.

In this example, Joe has scheduled incoming emails from Jeff to be flipped between 9 am and 5 pm PST on weekdays. At 9 am on Monday, the Job Processor at, for example the Telemail server 70 requests the JBoss server 72 (hereinafter “JBoss 72”) to run its schedule servlet. In response to this request, JBoss 72 queries the MySQL database 74 for Joe's account which has a pending scheduled event and retrieves the account information. JBoss activates flipping for Joe's account so that Telemail will periodically check Joe's account. Joe's account is seen in the mail-checking queue.

Telemail server 70 ask JBoss 72 for access to Joe's email account information (e.g. email provider, email address and email password) and his white-list which includes the approved senders and their associated nicknames. JBoss 72 sends the Telemail query to the MySQL database 74. JBoss 72 assembles and packages this information and then sends it back to Telemail servers 70. Telemail server 70 contacts Joe's email provider's POP server 76 and requests a list of unread emails from his inbox, one of which is Jeff s email. Telemail server 70 checks the sender of each email against Joe's white-list and finds Jeff s email address which is on the white-list and has the nickname of ‘Jeff’. Telemail sever 70 downloads the mail from Jeff s email account that is in Joe's inbox, bundles this email along with the sender's assigned nickname, ‘Jeff’, and Joe's mobile phone number and transfers the bundle to the Apache James Mail Server 78 (hereinafter “James 78”).

James 78 extracts the email's header and text contents and converts this information into an SMS message with a shortened subject line and return address. James 78 asks JBoss server 80 (hereinafter JBoss 80) for Joe's setting for the maximum number of fliplettes. JBoss 80 gets the fliplette setting from the MySQL database 82 and sends it back to James 78. James 78 slices the message body into one or more fliplettes which are formatted as SMS messages and then forwards the fliplettes to Open Market Exchange along with Joe's mobile phone number. The fliplettes include, for example, the sender's flipMail nickname, ‘Jeff’, so that Joe can reply if he desires. Open Market Exchange 84, for example, uses Joe's mobile phone number to find the appropriate carrier email/SMS gateway 86 for Joe's phone 88 and then sends the SMS messages to him.

In addition, as discussed below, the system according to the embodiments discussed herein can perform advertising operations to send various advertising content. There are several components involved in this process. The website will allow the company and vendors to specify campaign rules based on user's data. The system will allow for insertion of business rules to help in the selection of advertising content. The first iteration of the advertising system will focus on footer content which will be selected and inserted into user flipmails by the backend Java ad engine processes. The database (e.g., database 22 as discussed above, or any other suitable database) will be used to store these rules and content. In this example, approximately 8 tables will be added to the database 22 for the advertising engine and several other tables will be modified to support the system.

The core of the advertising process is based on processing rules to determine what advertisement is delivered to the user. The rules include rules that use business logic to select which rules to check the user against, and post processing rules to determine which rule is the appropriate one to use.

TABLE 1

| RuleAction | Target | CompOp | Value | LogicOp | Target | CompOp | Value |
|---|---|---|---|---|---|---|---|
| LOADRULE | VendorRuleID | = | UserVendorID | | | | |
| LOADRULE | VendorRuleID | = | UserAltVendorID | | | | |
| LOADRULE | VendorRuleID | = | Teleflip | | | | |
| MATCH | EmailDomain | = | Yahoo | | | | |
| MATCH | Carrier | = | sprint | OR | Carrier | = | tmobile |
| SELECTRULE | RuleWeight | = | Greatest | | | | |
| SELECTRULE | VendorWeight | = | Greatest | | | | |
| SELECTRULE | RuleMatches | = | Greatest | | | | |
| SELECTRULE | RulePool | = | Random | | | | |

Table 1 outlines an example of the core of the rule based system. The first three rules are business logic rules to determine which content rules are going to be used to determine the ad winner. These are called pre-processing rules. The two ‘MATCH’ rules would be vendor defined content rules specifying what demographic types that particular ad needs to match in order to be selected. These are called vendor rules. The remaining four rules are business logic rules to determine the winning rule. These are called post-processing rules. This table only shows the first two targets; however using the comparison operator, value, and logic operator values there can be up to ten of them for defining a rule.

If the system were using Table 1 it would do the following:
Line 1—load all the rules from the vendor that the user is associated with.
Line 2—load all the rules from any alternate vendor association for that user.
Line 3—load default rule set in case none of the vendor rules can be used.
Lines 4 and 5—matches the user demographic data against the rule definitions. If there is not a match, (using this example, if the user's email domain is not Yahoo) then that rule would be thrown out. If there is a match, then the rule is held and all matching rules are passed along to the post-processing section.
Line 6—Select from the remaining matching rules, in this case, the one with the greatest rule weight. The weight is assigned as a decimal (3.2) value to allow for translation to currency. So if 5 rules matched in the matching section it would pick the one that the vendor is willing to pay the most for. For example, $1.50 would be RuleWeight 1.50.
Line 7—If two or more rules are still remaining because two vendors are both willing to pay $1.50 for that ad, then the one with the greatest VendorWeight would be chosen. The VendorWeight would be something that the company would assign based on the relationship with the vendor. The weight of the vendor would be based on the vendor's relationship with the company, and can be viewed as a preferred vendor status in some aspect.
Line 8—If multiple matches exist because the vendor weights may have been the same the number of matches are examined. For example, if a rule says Email=Yahoo AND carrier=Sprint AND areacode=805 and it matched on all those then it would have a RuleMatches of 3. If another rule just had areacode=805, then it would have a RuleMatches of 1 and therefore the match with 3 would win this rule.
Line 9—If there were still multiple rules matching the system then we would use this rule to just select a winner randomly. This post-processing rule set would always contain a rule like this at the end just in case. It guarantees that only one rule will remain and be used.

It should also be noted that the tables to be added to the database allow for the ad engine functionality and flexibility. They allow for definitions of the RuleAction, targets, comparison and logical operators, as well as the possibility of targets being outside the database (a call to a web service for example). They also account for levels of authorization, in that some vendors may not be privy to all data points and probably no vendors will be able to see or use pre and post processing rule functions.

The AdRules table (Table 2 below) is where all rules are defined. Pre-processing, vendor-defined, and post- processing rules are defined within this table.

TABLE 2

| Column Name | Data Type | Description |
|---|---|---|
| Arid | BIGINT(20) | Auto Increment, Primary Key Rule ID Column |
| RuleType | TINYINT(1) | 1 = preprocess 2 = vendor 3 = post process |
| DateTimeLastModified | TIMESTAMP | |
| DateTimeCreated | TIMESTAMP | |
| VendorID | BIGINT(20) | Vendor who owns the rule |
| CampaignID | INT(4) | ID to group rules in campaigns for display |
| AdType | TINYINT(3) | 1 = footer 2 = full sms 3 = emailback |
| AdID | BIGINT(20) | ad table pointer with ad content |
| Status | TINYINT(1) | 0 = inactive 1 = active 2 = deleted 3 = deleted TF |
| ImpressionsTotal | INT(10) | Defined for impression based counting |
| ImpressionsCount | INT(10) | Running count of ad impressions for rule |
| StartDate | DATE | Defined for date based campaigns. |
| StopDate | DATE | Defined for date based campaigns. |
| Priority | TINYINT(1) | Vendor given priority |
| Weight | DECIMAL(3.2) | cost of the ad $1.50 |
| RuleAction | VARCHAR(30) | LOADRULE, MATCH, SELECTRULE etc |
| TargetType1 | TINYINT(2) | 1 = db lookup |
| Target1 | VARCHAR(40) | ‘Email Vendor’ or ‘Carrier’ |
| CompOp1 | VARCHAR(30) | ‘=’ or ‘>’ or ‘<’ comparison operators |
| ValueType1 | TINYINT(2) | 1 = db lookup, 2 = literal |
| Value1 | VARCHAR(40) | ‘yahoo.com’ or ‘Sprint’ |
| LogicOp1 | VARCHAR(30) | ‘AND’, ‘OR’ |
| TargetType2 | TINYINT(2) | 1 = db lookup |
| Target2 | VARCHAR(40) | ‘Email Vendor’ or ‘Carrier’ |
| CompOp2 | VARCHAR(30) | ‘=’ or ‘>’ or ‘<’ comparison operators |
| ValueType2 | TINYINT(2) | 1 = db lookup, 2 = literal |
| Value2 | VARCHAR(40) | ‘yahoo.com’ or ‘Sprint’ |
| LogicOp2 | VARCHAR(30) | ‘AND’, ‘OR’ |
| TargetType3 | TINYINT(2) | 1 = db lookup |
| Target3 | VARCHAR(40) | ‘Email Vendor’ or ‘Carrier’ |
| CompOp3 | VARCHAR(30) | ‘=’ or ‘>’ or ‘<’ comparison operators |
| ValueType3 | TINYINT(2) | 1 = db lookup, 2 = literal |
| Value3 | VARCHAR(40) | ‘yahoo.com’ or ‘Sprint’ |
| LogicOp3 | VARCHAR(30) | ‘AND’, ‘OR’ |
| TargetType4 | TINYINT(2) | 1 = db lookup |
| Target4 | VARCHAR(40) | ‘Email Vendor’ or ‘Carrier’ |
| CompOp4 | VARCHAR(30) | ‘=’ or ‘>’ or ‘<’ comparison operators |
| ValueType4 | TINYINT(2) | 1 = db lookup, 2 = literal |
| Value4 | VARCHAR(40) | ‘yahoo.com’ or ‘Sprint’ |
| LogicOp4 | VARCHAR(30) | ‘AND’, ‘OR’ |
| TargetType5 | TINYINT(2) | 1 = db lookup |
| Target5 | VARCHAR(40) | ‘Email Vendor’ or ‘Carrier’ |
| CompOp5 | VARCHAR(30) | ‘=’ or ‘>’ or ‘<’ comparison operators |
| ValueType5 | TINYINT(2) | 1 = db lookup, 2 = literal |
| Value5 | VARCHAR(40) | ‘yahoo.com’ or ‘Sprint’ |
| LogicOp5 | VARCHAR(30) | ‘AND’, ‘OR’ |
| TargetType6 | TINYINT(2) | 1 = db lookup |
| Target6 | VARCHAR(40) | ‘Email Vendor’ or ‘Carrier’ |
| CompOp6 | VARCHAR(30) | ‘=’ or ‘>’ or ‘<’ comparison operators |
| ValueType6 | TINYINT(2) | 1 = db lookup, 2 = literal |
| Value6 | VARCHAR(40) | ‘yahoo.com’ or ‘Sprint’ |
| LogicOp6 | VARCHAR(30) | ‘AND’, ‘OR’ |
| TargetType7 | TINYINT(2) | 1 = db lookup |
| Target7 | VARCHAR(40) | ‘Email Vendor’ or ‘Carrier’ |
| CompOp7 | VARCHAR(30) | ‘=’ or ‘>’ or ‘<’ comparison operators |
| ValueType7 | TINYINT(2) | 1 = db lookup, 2 = literal |
| Value7 | VARCHAR(40) | ‘yahoo.com’ or ‘Sprint’ |
| LogicOp7 | VARCHAR(30) | ‘AND’, ‘OR’ |
| TargetType8 | TINYINT(2) | 1 = db lookup |
| Target8 | VARCHAR(40) | ‘Email Vendor’ or ‘Carrier’ |
| CompOp8 | VARCHAR(30) | ‘=’ or ‘>’ or ‘<’ comparison operators |
| ValueType8 | TINYINT(2) | 1 = db lookup, 2 = literal |
| Value8 | VARCHAR(40) | ‘yahoo.com’ or ‘Sprint’ |
| LogicOp8 | VARCHAR(30) | ‘AND’, ‘OR’ |
| TargetType9 | TINYINT(2) | 1 = db lookup |
| Target9 | VARCHAR(40) | ‘Email Vendor’ or ‘Carrier’ |
| CompOp9 | VARCHAR(30) | ‘=’ or ‘>’ or ‘<’ comparison operators |
| ValueType9 | TINYINT(2) | 1 = db lookup, 2 = literal |
| Value9 | VARCHAR(40) | ‘yahoo.com’ or ‘Sprint’ |
| LogicOp9 | VARCHAR(30) | ‘AND’, ‘OR’ |
| TargetType10 | TINYINT(2) | 1 = db lookup |
| Target10 | VARCHAR(40) | ‘Email Vendor’ or ‘Carrier’ |
| CompOp10 | VARCHAR(30) | ‘=’ or ‘>’ or ‘<’ comparison operators |
| ValueType10 | TINYINT(2) | 1 = db lookup, 2 = literal |
| Value10 | VARCHAR(40) | ‘yahoo.com’ or ‘Sprint’ |
| LogicOp10 | VARCHAR(30) | ‘AND’, ‘OR’ |

The AdOpDefinition Table (Table 3) handles defining the rule action, comparison operator, and logic operators. As code is implemented to support different functions, these operators will be added here to prevent the front end code from having to be rewritten to support new functions. It also defines who can see what with the OperatorClassBitmap. This will prevent vendors from seeing operators that are specific, such as ‘LOADRULE’ for example.

TABLE 3

| Column Name | Data Type | Description |
|---|---|---|
| aodID | BIGINT(2) | Auto Increment, PK |
| OperatorType | TINYINT(3) | 1 = rule action (MATCH) |
| | | 2 = comparison operator |
| | | (‘=’ ‘>’) 3 = |
| | | logic operator (‘AND’ ‘OR) |
| OperatorClassBitmap | BIGINT(3) | Who has access to this |
| OperatorName | VARCHAR(30) | ‘MATCH’, ‘AND’, ‘>’ |

The SystemDataDef Table (Table 4) handles defining Data Types such as ‘Carrier’ and ‘Email Provider’ or ‘VendorDefined1’. The DefDataLocation is the location of the data to be looked at. The type specifies what type of lookup is to be done and the Bitmap defines who has access to see this data. It again prevents the front end from having to be hard coded with the various keywords such as ‘Carrier’ or ‘Email Provider’ and the back-end uses it to find the location of the data and what module it should use to get the value.

TABLE 4

| Column Name | Data Type | Description |
|---|---|---|
| sddID | BIGINT(20) | Auto Increment, PK |
| DefType | TINYINT(2) | 1 = DB lookup, 2 = API, |
| | | 3 = script |
| DefName | VARCHAR(40) | ‘Carrier’ or ‘Email Provider’ |
| DefDataLocation | VARCHAR(255) | ‘Mobiles.CarrierID’, |
| | | ‘view1.EmailProvider’ |
| DefBitMap | BIGINT(2) | Who has access to see this |

The .FooterAds Table (Table 5) defines the actual footer ad. A similar table would be used to define full SMS ads or email back ads or other ad types that eventually get defined. This table accommodates a review process: any ad that has Reviewed=1 and Approved=1 would be considered a valid ad to be used by a rule if the vendor desired. Vendors would be able to define several ads without having to define rules for the ad and upon review and approval they would then be able to place the ad into a rule.

TABLE 5

| Column Name | Data Type | Description |
|---|---|---|
| faID | BIGINT(20) | Auto Increment, PK |
| DateTimeCreated | TIMESTAMP | Time of ad insertion |
| VendorID | BIGINT(20) | VendorID |
| Reviewed | TINYINT(1) | 0 = not reviewed, 1 = reviewed |
| Approved | TINYINT(1) | 0 = not approved, 1 = approved |
| Comment | VARCHAR(255) | Reviewer comment if any |
| AdText | VARCHAR(40) | Actual footer ad content |

The .AdLog Table (Table 6) is the main log table for the ad system. It basically points back to the ad that was sent, the time it was sent, and to who it was sent.

TABLE 6

| Column Name | Data Type | Description |
|---|---|---|
| adlogID | BIGINT(20) | Auto Increment, PK |
| DateTimeSent | TIMESTAMP | When was the Ad sent |
| UserID | BIGINT(20) | User who the Ad was sent to |
| AdType | TINYINT(2) | 1 = footer 2 = full sms 3 = emailback |
| AdID | BIGINT(20) | ID of the ad from the appropriate table |

Although only a few exemplary embodiments of the present invention have been described in detail above, those skilled in the art will readily appreciate that many modifications are possible in the exemplary embodiments without materially departing from the novel teachings and advantages of this invention. For example, the order and functionality of the steps shown in the processes may be modified in some respects without departing from the spirit of the present invention. Accordingly, all such modifications are intended to be included within the scope of this invention.

1. A method for email messaging to a targeted recipient device associated with a network carrier, without a sender having prior knowledge of network dependent syntax for email addressing for the particular network carrier, comprising:
operating the sender addressing an email message to a messaging server based on an alias associated with the recipient and an email domain associated with the messaging server; and
operating the messaging server to determine recipient's network carrier based on the alias, and route the email message to the network carrier based on the network dependent syntax, so that the network carrier can forward the email message to the recipient.

2. The method of claim 1, wherein the alias include an alphanumeric identifier.

3. The method of claim 2, wherein the alphanumeric identifier is uniquely associated with the recipient's device, wherein the alphanumeric identifier is network independent across carrier networks.

4. The method of claim 2, wherein the alphanumeric identifier comprises alphanumeric characters representing recipient's wireless telephone.

5. The method of claim 2, wherein the alphanumeric representation comprises an alphanumeric identifier that is user assigned.

6. The method of claim 5, wherein the alphanumeric identifier is assigned by the sender or recipient.

7. The method of claim 5, wherein the alphanumeric identifier comprises a nickname of the recipient.

8. The method of claim 1, wherein the messaging server determines recipient's network carrier by looking up a database containing association of aliases and network carriers.

9. The method of claim 8, wherein the aliases comprise alphanumeric identifiers that are (a) uniquely associated with the recipients' devices, wherein the alphanumeric identifiers are network independent across carrier networks; or (b) user assigned.

10. The method of claim 9, wherein in the case of the alphanumeric identifiers being uniquely associated with the recipient's devices, such association is independent of participation by the carrier's customers.

11. The method of claim 9, wherein in the case of the user assigned alphanumeric identifier, the messaging server determines a device identifier that is uniquely associated with the recipient's device, wherein the device identifier is network independent across carrier networks, and determines the network carrier associated with the device identifier, thereby routing the email message to the network carrier based on the network dependent syntax for email messaging.

12. The method of claim 11, wherein in the case of the alphanumeric identifiers being uniquely associated with the recipient's devices, such association is independent of participation by the carrier's customers.

13. The method of claim 12, wherein the alias comprises a nickname assigned to be associated with the recipient.

14. A computer-readable medium of instructions for controlling a server to perform email messaging to a targeted recipient device associated with a network carrier, without a sender having prior knowledge of network dependent syntax for email addressing for the particular network carrier, comprising:
a first set of instructions to control a messaging server to receive an email message that was created by the sender based on an alias associated with the recipient and an email domain associated with the messaging server; and
a second set of instructions for controlling the messaging server to determine recipient's network carrier based on the alias, and route the email message to the network carrier based on the network dependent syntax, so that the network carrier can forward the email message to the recipient.

15. The computer-readable medium of instructions of claim 14, wherein the alias include an alphanumeric identifier.

16. The computer-readable medium of instructions of claim 15, wherein the alphanumeric identifier is uniquely associated with the recipient's device, wherein the alphanumeric identifier is network independent across carrier networks.

17. The computer-readable medium of instructions of claim 15, wherein the alphanumeric identifier comprises alphanumeric characters representing recipient's wireless telephone.

18. The computer-readable medium of instructions of claim 15, wherein the alphanumeric representation comprises an alphanumeric identifier that is user assigned.

19. The computer-readable medium of instructions of claim 15, wherein the alphanumeric identifier is assigned by the sender or recipient.

20. The computer-readable medium of instructions of claim 15, wherein the alphanumeric identifier comprises a nickname of the recipient.
